(19) United States
(12) Patent Application Publication
(10) Pub. No.: US 2014/0049988 A1
(43) Pub. Date: Feb. 20, 2014

(54) LIGHT DEFLECTION FILM

(71) Applicant: INDUSTRIAL TECHNOLOGY RESEARCH INSTITUTE, (US)

(72) Inventors: Hui-Hsiung Lin, Miaoli County (TW); Chi-Hung Liao, Tainan (TW); Wen-Hsun Yang, Taipei (TW)

(73) Assignee: INDUSTRIAL TECHNOLOGY RESEARCH INSTITUTE, Hsinchu (TW)

(21) Appl. No.: 13/854,677

(22) Filed: Apr. 1, 2013

(30) Foreign Application Priority Data
Aug. 15, 2012 (TW) 101129620

(51) Int. Cl. F21V 5/02

(52) U.S. Cl. CPC F21V 5/02
USPC 362/616; 362/339

(57) ABSTRACT

A light deflection film is provided, which includes an incident surface including a plurality of first prism structures, and an emission surface including a plurality of second prism structures. The first prism structure includes a first surface and a second surface, a first angle between the first surface and an X-axis is 0 to 20 degree, a second angle between the second surface and a Y-axis is 5 to 60 degree. The second prism structure comprises a third surface and a fourth surface, a third angle between the third surface and the X-axis is 0 to 20 degree, a fourth angle between the fourth surface and the Y-axis is 5 to 60 degree. Thus, as implemented in windows, the light deflection film may guide partial sunlight to a ceiling to increase ambient brightness, reduce the usage quantity of illumination devices, and avoid glare.

### CROSS-REFERENCE STATEMENT

This non-provisional application claims priority under 35 U.S.C. §119(a) on Patent Application No(s). 101129620 filed in Taiwan, R.O.C. on Aug. 15, 2012, the entire contents of which are hereby incorporated by reference.

### TECHNICAL FIELD

The disclosure relates to an optical film, and more particularly to an optical film for deflecting light.

### BACKGROUND

With the development of technology and economic, life quality people request is getting higher, and that may cause crude oil is getting less. Over the years, various green energy technologies are developed because of higher environment protection sense, and energy conservation in the illumination art is one of the important targets thereof. It is necessary at night for illumination apparatus to provide light, so is it at daytime. Thus, indirect illumination technology is developed to guide outdoor sunlight to be indirect illumination light, so as to meet the request of energy conservation.

In the present art, some skills, e.g. reflection film and prism structure element, are developed to carry out above indirect illumination purpose. Specifically, the reflection film is used to reflect outdoor sunlight to the indoor ceiling so as to provide indirect illumination for indoor space. However, such a reflection film may block outdoor scenery.

The prism structure element is used to guide outdoor sunlight to indoor ceiling and has flat regions which outdoor scenery may not be blocked by. However, the partial sunlight guided by prism structure element may cause glare. Therefore, an optical film, which guides sunlight from outdoor space to indoor space and does not cause glare, is developed.

### SUMMARY

The disclosure provides one embodiment which relates to a light deflection film, which is adapted to receive light and comprises an incident surface and an emission surface. The incident surface comprises a plurality of first prism structures, the first prism structure comprises a first surface and a second surface, a first angle between the first surface and an X-axis is 0 to 20 degree, a second angle between the second surface and a Y-axis is 5 to 60 degree. The emission surface comprises a plurality of second prism structures, the second prism structure comprises a third surface and a fourth surface, a third angle between the third surface and the X-axis is 0 to 20 degree, and a fourth angle between the fourth surface and the Y-axis is 5 to 60 degree. Light is emitted out of the emission surface after penetrating into the light deflection film from the incident surface.

The disclosure provides one embodiment which relates to a light deflection film, which is adapted to receive light and comprises a first light guiding plate, a second light guiding plate and an air layer. The first light guiding plate comprises an emission surface and a first structure surface comprising a plurality of first prism structures. The first prism structure comprises a first surface and a second surface, a first angle between the first surface and an X-axis is 0 to 15 degree, and a second angle between the second surface and a Y-axis is 5 to 45 degree. The second light guiding plate comprises an emission surface and a second structure surface comprising a plurality of second prism structures. The second prism structure comprises a third surface and a fourth surface, a third angle between the third surface and the X-axis is 0 to 15 degree, and a fourth angle between the fourth surface and the Y-axis is 5 to 45 degree. The air layer is disposed between the first structure surface and the second structure surface. Light penetrates into the light deflection film from the incident surface and emits out of the emission surface.

For purposes of summarizing, some aspects, advantages and features of some embodiments of the disclosure have been described in this summary. Not necessarily all of (or any of) these summarized aspects, advantages or features will be embodied in any particular embodiment of the disclosure. Some of these summarized aspects, advantages and features and other aspects, advantages and features may become more fully apparent from the following detailed description and the appended claims.

### BRIEF DESCRIPTION OF THE DRAWINGS

The present disclosure will become more fully understood from the detailed description given herein below for illustration only, and thus are not limitative of the present disclosure, and wherein:

FIG. 1 is a sectional schematic diagram of a profile structure of a light deflection film according to a first embodiment of the disclosure;

FIG. 2A-FIG. 2J are schematic diagrams of light distribution curve of the light deflection film of FIG. 1 which light penetrates into by elevation angles of 5, 15, 25, 35, 45, 55, 65, 75, 80 and 85 degree respectively;

FIG. 3 is a schematic diagram of power percentage curves of the complete emitted light, of the deflected light in a ceiling direction, and of the deflected light in a floor direction when light penetrates into the light deflection film of FIG. 1 by elevation angles of 5 to 85 degree respectively;

FIG. 4A is a sectional schematic diagram of a profile structure of a light deflection film according to a second embodiment of the disclosure;

FIG. 4B and FIG. 4C are schematic diagrams of power percentage curve of the complete emitted light, of the deflected light in a ceiling direction, and of the deflected light in a floor direction when light penetrates into the light deflection film of FIG. 4A by elevation angles of 5 to 85 degree respectively;

FIG. 5 is a sectional schematic diagram of a profile structure of a light deflection film according to a third embodiment of the disclosure;

FIG. 6A-FIG. 6H are schematic diagrams of light distribution curve of the light deflection film of FIG. 5 which light penetrates into by elevation angles of 10, 20, 30, 40, 50, 60, 70 and 80 degree respectively;

FIG. 6I is a schematic diagram of power percentage curves of the complete emitted light, of the deflected light in a ceiling direction, and of the deflected light in a floor direction when light penetrates into the light deflection film of FIG. 5 by elevation angles of 5 to 85 degree respectively;

FIG. 6J is a schematic diagram of a simulate power percentage curve and a measured power percentage curve of the deflected light in a ceiling direction;

FIG. 7A is a sectional schematic diagram of a profile structure of a light deflection film according to a fourth embodiment of the disclosure;

FIG. 7B and FIG. 7C are schematic diagrams of power percentage curve of the complete emitted light, of the deflected light in a ceiling direction, and of the deflected light in a floor direction when light penetrates into the light deflection film of FIG. 7A by elevation angles of 5 to 85 degree respectively;

FIG. 8 is a sectional schematic diagram of a profile structure of a light deflection film according to a fifth embodiment of the disclosure;

FIG. 9 is a sectional schematic diagram of a profile structure of a light deflection film according to a sixth embodiment of the disclosure;

FIG. 10A-FIG. 10H are schematic diagrams of light distribution curve of the light deflection film of FIG. 9 which light penetrates into by elevation angles of 10, 20, 30, 40, 50, 60, 70 and 80 degree respectively;

FIG. 10I is a schematic diagram of power percentage curves of the complete emitted light, of the deflected light in a ceiling direction, and of the deflected light in a floor direction when light penetrates into the light deflection film of FIG. 9A by different elevation angles respectively;

FIG. 11 is a sectional schematic diagram of a profile structure of a light deflection film according to a seventh embodiment of the disclosure;

FIG. 12A-FIG. 12H are schematic diagrams of light distribution curve of the light deflection film of FIG. 11 which light penetrates into by elevation angles of 10, 20, 30, 40, 50, 60, 70 and 80 degree respectively;

FIG. 12I is a schematic diagram of power percentage curves of the complete emitted light, of the deflected light in a ceiling direction, and of the deflected light in a floor direction when light penetrates into the light deflection film of FIG. 11 by different elevation angles respectively;

FIG. 13 is a sectional schematic diagram of a profile structure of a light deflection film according to an eighth embodiment of the disclosure;

FIG. 14A-FIG. 14H are schematic diagrams of light distribution curve of the light deflection film of FIG. 13 which light penetrates into by elevation angles of 10, 20, 30, 40, 50, 60, 70 and 80 degree respectively;

FIG. 14I is a schematic diagram of power percentage curves of the complete emitted light, of the deflected light in a ceiling direction, and of the deflected light in a floor direction when light penetrates into the light deflection film of FIG. 13 by different elevation angles respectively; and

FIG. 15 is a sectional schematic diagram of a profile structure of a light deflection film according to a ninth embodiment of the disclosure.

### DETAILED DESCRIPTION

The detailed features and advantages of the disclosure are described below in great detail through the following embodiments, the content of which is sufficient for those of ordinary skill in the art to understand the technical content of the disclosure and to implement the disclosure accordingly. Based upon the content of the specification, the claims, and the drawings, those of ordinary skill in the art can easily understand the relevant objectives and advantages of the disclosure.

For explanation of the disclosure, one embodiment of a light deflection film implemented in a window is taken for illustration hereinafter.

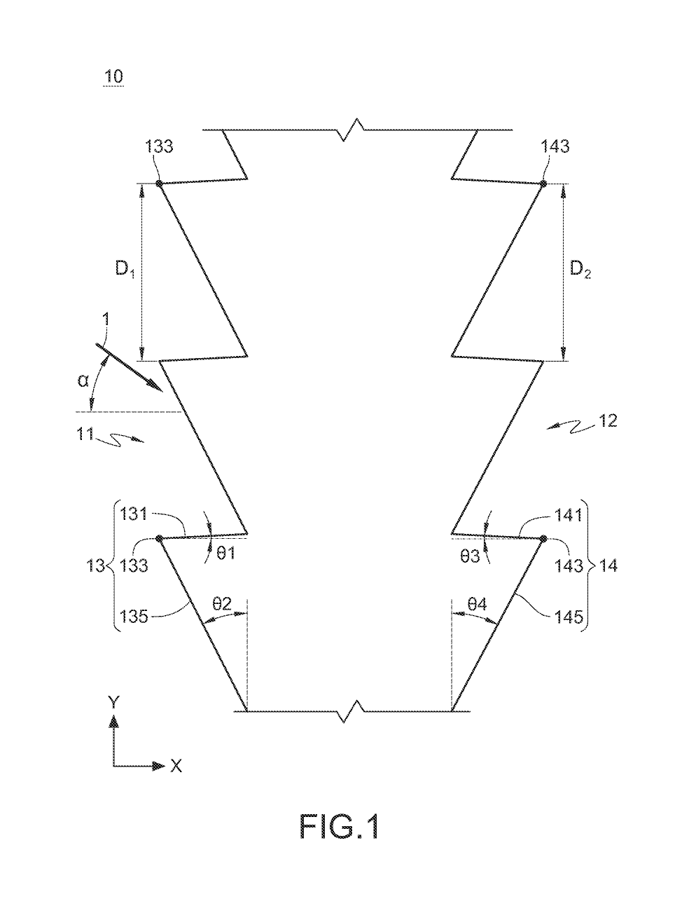

FIG. 1 illustrates a sectional schematic diagram of a profile structure of a light deflection film according to a first embodiment of the disclosure. The light deflection film 10 includes an incident surface 11 and an emission surface 12. Light 1 penetrates into the light deflection film 10 from the incident surface 11 by an elevation angle a.

The incident surface 11 includes a plurality of first prism structures 13 arranged at the incident surface 11 along a Y-axis. The emission surface 12 includes a plurality of second prism structures 14 arranged at the emission surface 12 along the Y-axis. In this embodiment, only three first prism structures 13 and three second prism structures 14 are taken in FIG. 1 for illustration purpose.

Each first prism structure 13 includes a first surface 131 and a second surface 135. The first surface 131 and the second surface 135 meet to form a first vertex 133. A distance D₁ between two adjacent first vertexes 133 is from 1 micrometer to 20 millimeter. The first surface 131 and an X-axis meet to form a first angle θ1. The second surface 135 and the Y-axis meet to form a second angle θ2. The first angle θ1 may be, but not limit to, from 0 to 20 degree. In one embodiment, the first angle θ1 is from 0 to 15 degree. In another embodiment, the first angle θ1 is from 0 to 10 degree. The second angle θ2 may be, but not limit to, from 5 to 35 degree. In one embodiment, the second angle θ2 is from 15 to 30 degree.

Each second prism structure 14 includes a third surface 141 and a fourth surface 145. The third surface 141 and the fourth surface 145 meet to form a second vertex 143. A distance D₂ between two adjacent second vertexes 143 is from 1 micrometer to 20 millimeter. The third surface 141 and the X-axis meet to form a third angle θ3. The fourth surface 145 and the Y-axis meet to form a fourth angle θ4. The third angle θ3 may be, but not limit to, from 0 to 20 degree. In one embodiment, the third angle θ3 is from 0 to 15 degree. In another embodiment, the third angle θ3 is from 0 to 10 degree. The fourth angle θ4 may be, but not limit to, from 20 to 60 degree. In one embodiment, the fourth angle θ4 is from 25 to 45 degree.

Besides, the range of the second angle θ2 and the fourth angle θ4 may be exchanged. In other word, both the second angle θ2 and the fourth angle θ4 may be from 5 to 60 degree in accordance with application requests.

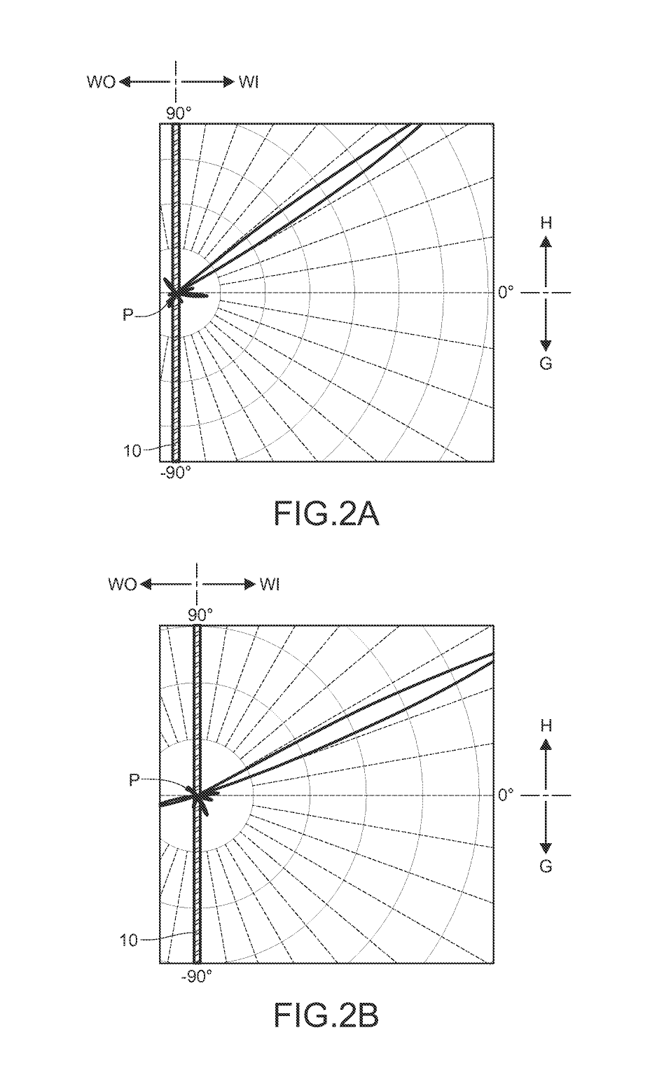

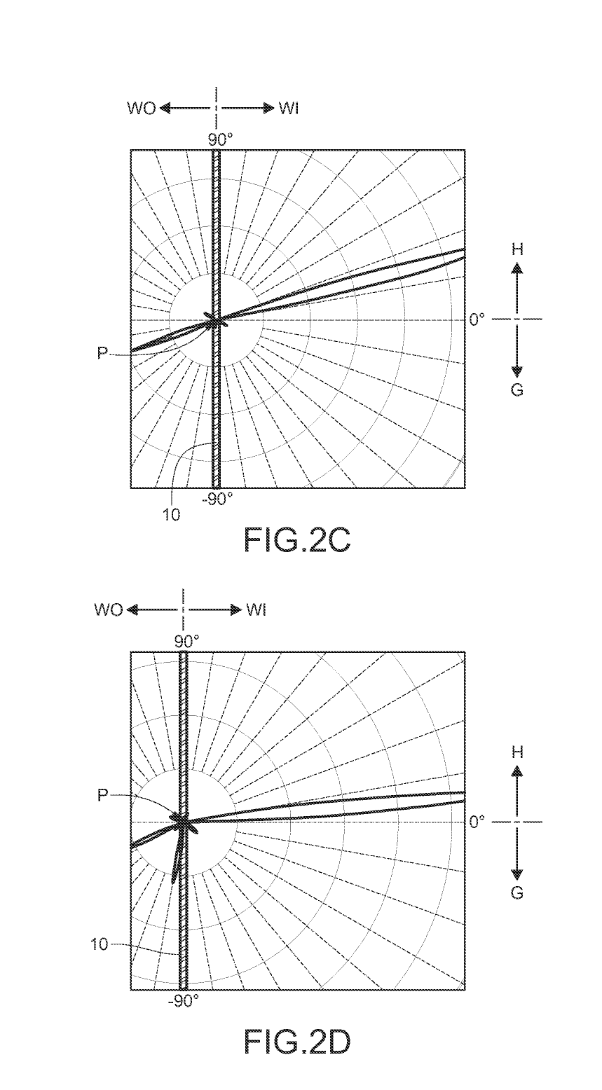

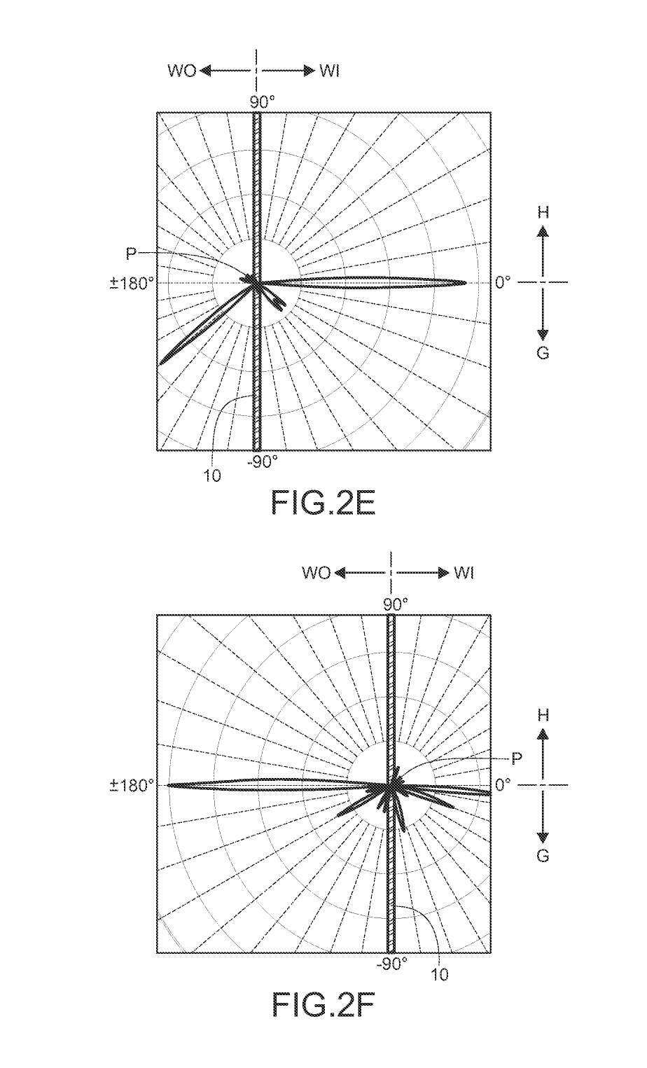

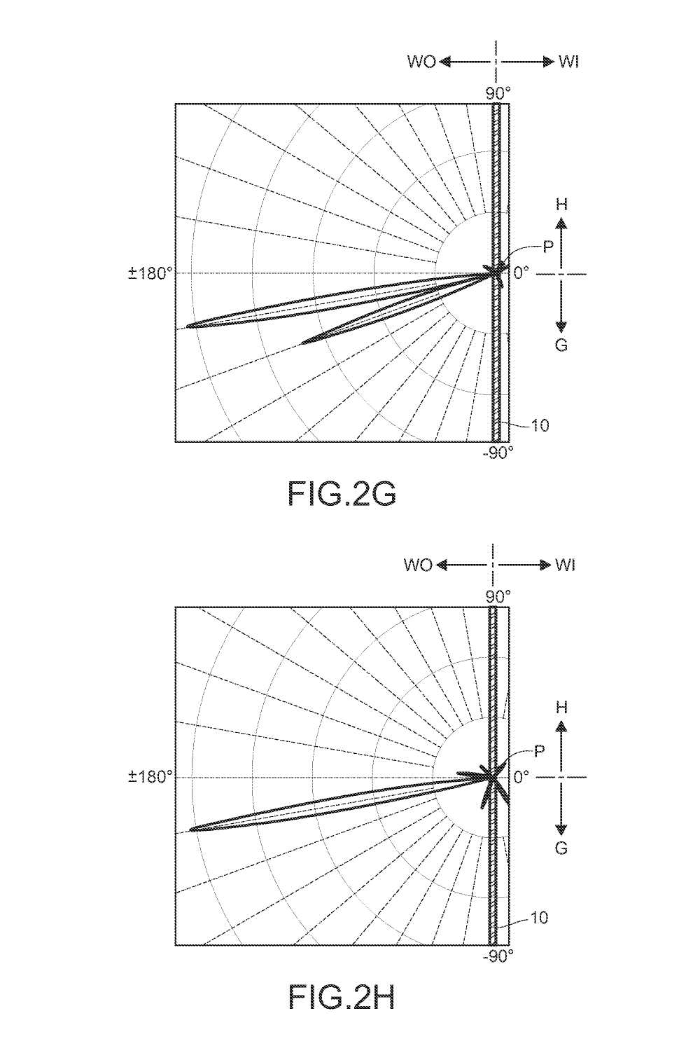

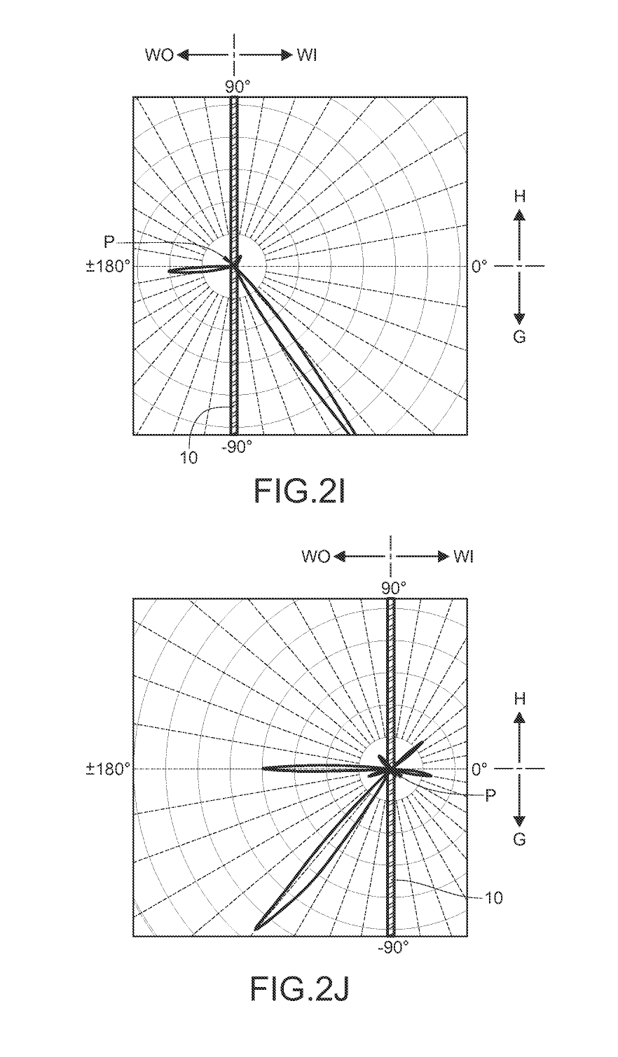

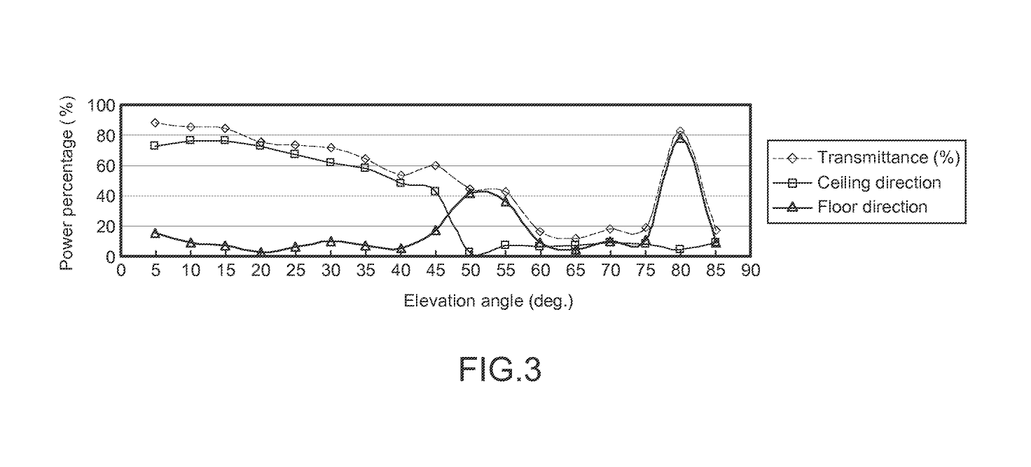

One embodiment of the light deflection film 10 is provided shown as FIG. 2A to FIG. 2J and FIG. 3. FIG. 2A to FIG. 2J illustrate schematic diagrams of light distribution curve of the light deflection film of FIG. 1 which light penetrates into by elevation angles of 5, 15, 25, 35, 45, 55, 65, 75, 80 and 85 degree respectively. FIG. 3 illustrates a schematic diagram of power percentage curves of the complete emitted light, of the deflected light in a ceiling direction, and of the deflected light in a floor direction when light penetrates into the light deflection film of FIG. 1 by elevation angles of 5 to 85 degree respectively.

In this embodiment, the distances D₁ and D₂ are 50 micrometer. The first angle θ1 is 3 degree. The second angle θ2 is 27 degree. The third angle θ3 is 3 degree. The fourth angle θ4 is 28 degree.

Center P indicates the position where Light 1 penetrates into the light deflection film 10. Each concentric arc indicates the light intensity which light 1 penetrates the light deflection film 10 from the outdoor space WO to the indoor space WI. Each radial line indicates the angle between light and the normal line (line of 0 degree) while light 1 penetrates the light deflection film 10, and a regular interval between two adjacent radial lines is 10 degree. The range from +90 degree through 0 degree to −90 degree indicates indoor space WI. The range from +90 degree through ±180 degree to −90 degree indicates outdoor space WO. The range from 0 degree to +90 degree indicates that light 1 is deflected toward the ceiling direction H (upper deflection) after penetrating the light deflection film 10. The range from −90 degree to 0 degree indicates that light 1 is deflected toward the floor direction G (down deflection) after penetrating the light deflection film 10.

In FIG. 3, the solid line curve with squares indicates the power percentage of the light in the ceiling direction H accounting for light 1 penetrating the light deflection film 10, the solid line curve with triangles indicates the power percentage of the light in the floor direction G accounting for light 1 penetrating the light deflection film 10, and the dotted line curve with rhombuses indicates the transmittance of light 1 penetrating the light deflection film 10. The sum of the power percentage of the light in the ceiling direction H and in the floor direction G is the power percentage of light 1 penetrating the light deflection film 10.

The elevation angle α larger than 55 degree occurs just about at noon, where it is not necessary to use any illumination device in the indoor space WI. Moreover, the power percentage of the light penetrating the light deflection film 10 may be not very large if the elevation angle α is larger than 55 degree. This may avoid increasing the temperature of the indoor space WI. Moreover, the power percentage of the light penetrating the light deflection film 10 is about 80 percent if the elevation angle α is 80 degree, and the position of the light shooting into the indoor space WI may be more closed to the light deflection film 10 as shown as FIG. 21. Thus, glare may be avoided.

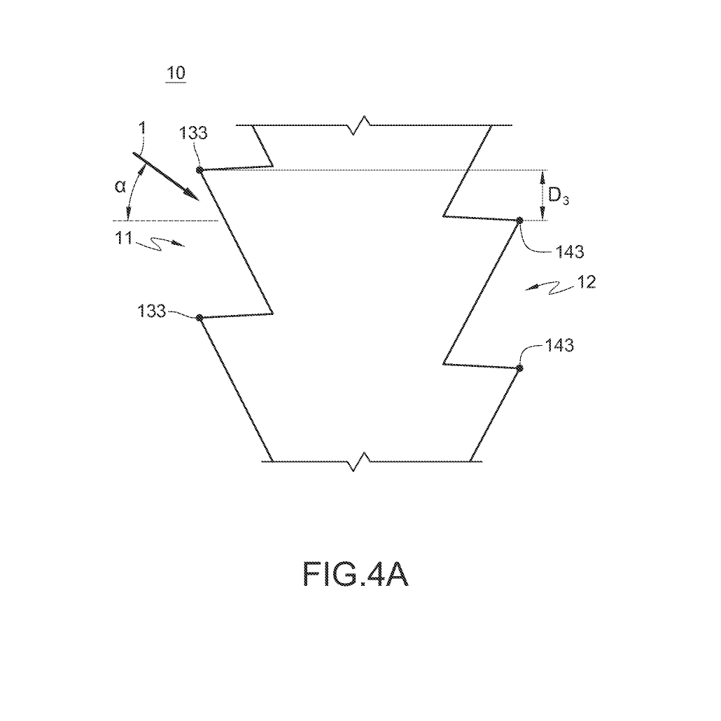

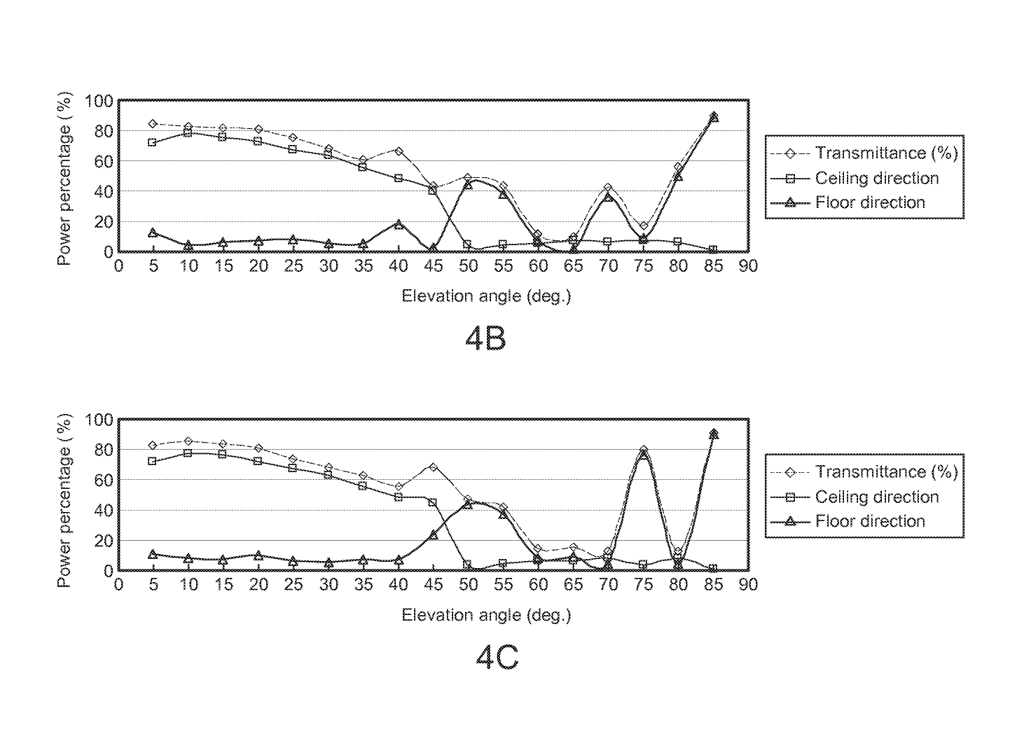

Referring to FIG. 4A, the difference between the first and second embodiments is that the position of the first vertex 133 of the first prism structure 13 and the position of the second vertex 143 of the second prism structure 14 are at different levels at Y axis in the second embodiment. More particularly, as compared with the position of each first prism structure 13 at the Y-axis, the position of each second prism structure 14 is shifted by a distance D₃ at the emission surface 12 along Y axis. The distance D₃ is the minimum height difference between the first vertex 133 and the second vertex 143. Other conditions of the second embodiment are equal to those of the first embodiment. Two embodiments of the light deflection film 10 of FIG. 4A are described in FIG. 4B and FIG. 4C.

In one embodiment, the first angle θ1 is 3 degree, the second angle θ2 is 27 degree, the third angle θ3 is 3 degree, the fourth angle θ4 is 28 degree, and the distance D₃ is 17 micrometer. When light 1 penetrates into such a light deflection film 10 of FIG. 4A by elevation angles of 5 to 85 degree, the power percentage curves of the complete emitted light, of the deflected light in a ceiling direction, and of the deflected light in a floor direction are shown in FIG. 4B.

In another embodiment, the first angle θ1 is 3 degree, the second angle θ2 is 27 degree, the third angle θ3 is 3 degree, the fourth angle θ4 is 28 degree, and the distance D₃ is 34 micrometer. When light 1 penetrates into such a light deflection film 10 of FIG. 4A by elevation angles of 5 to 85 degree respectively, the power percentage curves of the complete emitted light, of the deflected light in a ceiling direction, and of the deflected light in a floor direction are shown in FIG. 4C.

According to FIG. 3, FIG. 4B and FIG. 4C, if the shape and the angles of each first prism structure 13 and of each second prism structure 14 in FIG. 1 are equal to those in FIG. 4A, it may not affect the efficiency of the light deflection film 10 guiding light 1 into the ceiling in the indoor space WI too much that the emission surface 12 is shifted by the distances D₃ as compared with the incident surface 11.

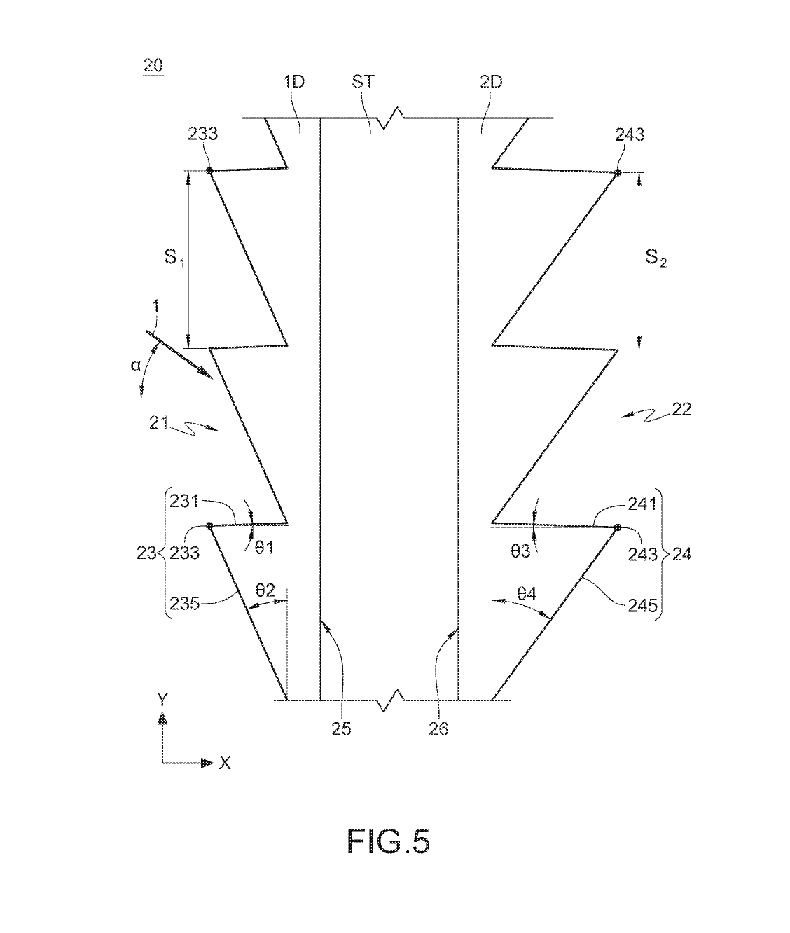

Referring FIG. 5, the light deflection film 20 of the third embodiment includes a first light guiding plate 1D, a second light guiding plate 2D and a transparent plate ST. The first light guiding plate 1D includes an incident surface 21 and a first flat surface 25. The incident surface 21 is opposite to the first flat surface 25. The second light guiding plate 2D includes an emission surface 22 and a second flat surface 26. The transparent plate ST is disposed between the first flat surface 25 and the second flat surface 26. Light 1 penetrates into the light deflection film 20 from the incident surface 21 by an elevation angle α.

The incident surface 21 includes a plurality of first prism structures 23 arranged at the incident surface 21 along a Y-axis. The emission surface 22 includes a plurality of second prism structures 24 arranged at the emission surface 22 along the Y-axis.

Each first prism structure 23 includes a first surface 231 and a second surface 235. The first surface 231 and the second surface 235 meet to form a first vertex 233. A distance S₁ between two adjacent first vertexes 233 is from 1 micrometer to 20 millimeter. The first surface 231 and the X-axis meet to form a first angle θ1. The second surface 235 and the Y-axis meet to form a second angle θ2. The first angle θ1 may be, but not limit to, from 0 to 20 degree. In one embodiment, the first angle θ1 is from 0 to 15 degree. In another embodiment, the first angle θ1 is from 0 to 10 degree. The second angle θ2 may be, but not limit to, from 5 to 35 degree. In one embodiment, the second angle θ2 is from 15 to 30 degree.

Each second prism structure 24 includes a third surface 241 and a fourth surface 245. The third surface 241 and the fourth surface 245 meet to form a second vertex 243. A distance S₂ between two adjacent second vertexes 243 is from 1 micrometer to 20 millimeter. The third surface 241 and the X-axis meet to form a third angle θ3. The fourth surface 245 and the Y-axis meet to form a fourth angle θ4. The third angle θ3 may be, but not limit to, from 0 to 20 degree. In one embodiment, the third angle θ3 is from 0 to 15 degree. In another embodiment, the third angle θ3 is from 0 to 10 degree. The fourth angle θ4 may be, but not limit to, from 20 to 60 degree. In one embodiment, the fourth angle θ4 is from 25 to 45 degree.

Besides, the range of the second angle θ2 and the range of the fourth angle θ4 may be exchanged. In other word, both the second angle θ2 and the fourth angle θ4 may be from 5 to 60 degree in accordance with application requests.

Moreover, the amount of the first prism structures 23, and of the second prism structures 24 in FIG. 5 are taken for illustration purpose and should not limit the scope of the disclosure. The first light guiding plate 1D and the second light guiding plate 2D may be made of UV glue. The transparent substrate ST may be made of polyethylene terephthalate (PET). The material of the first light guiding plate 1D, of the second light guiding plate 2D, and of the transparent substrate ST may be designed according to application requests and should not limit the scope of the disclosure.

In one embodiment, a metal die (not shown) and the skill of roll forming are used to perform UV curing. The first prism structures 23 and the second prism structures 24 on the metal die are transferred to the transparent substrate ST.

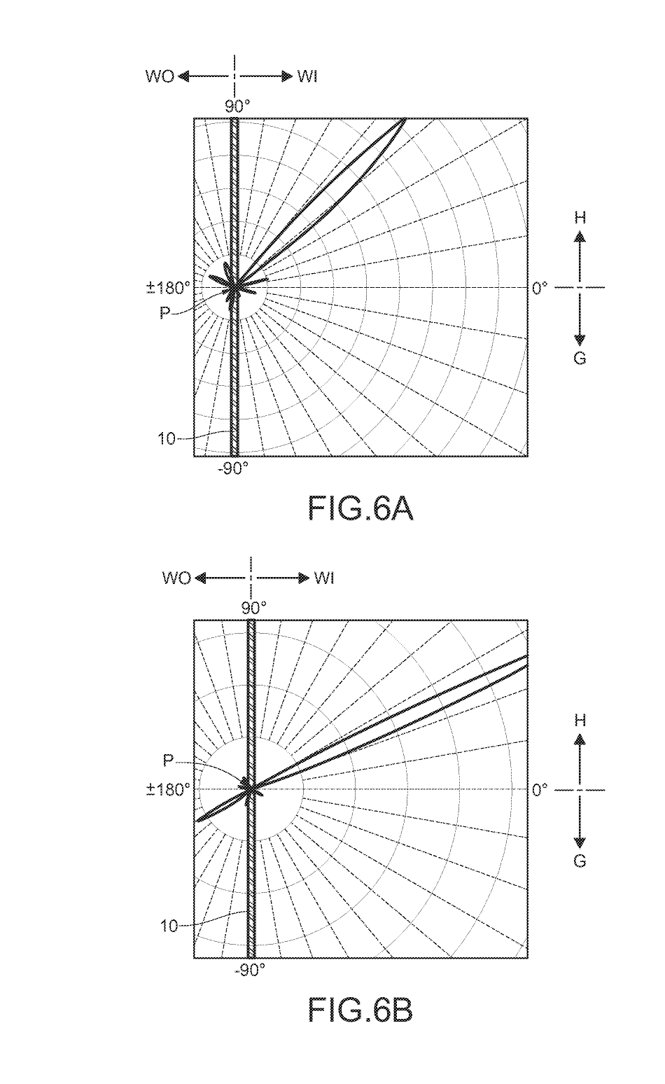

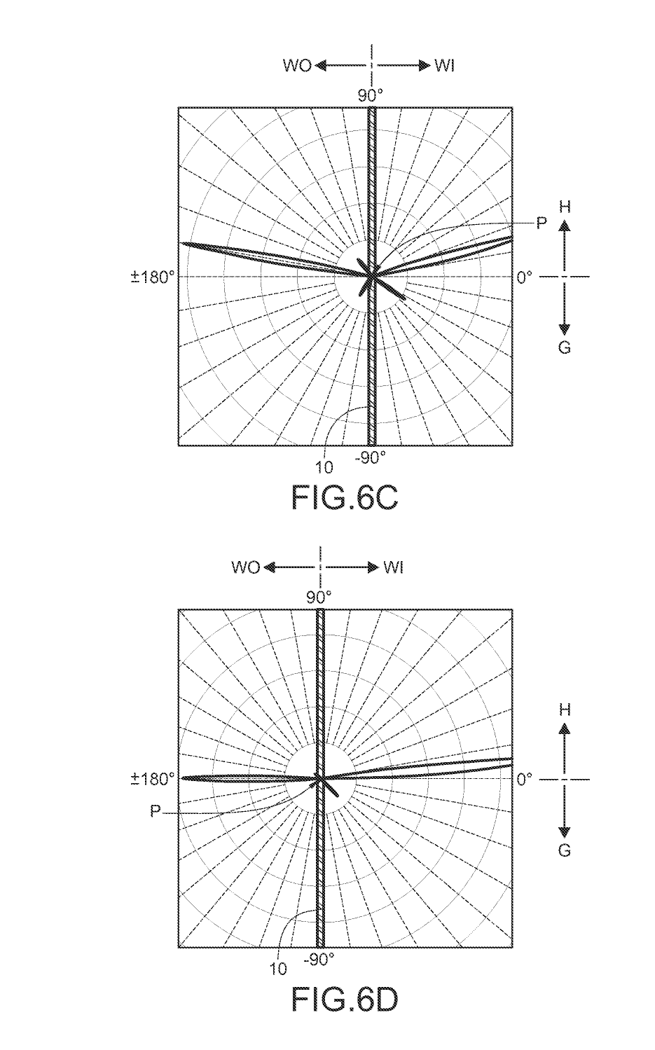

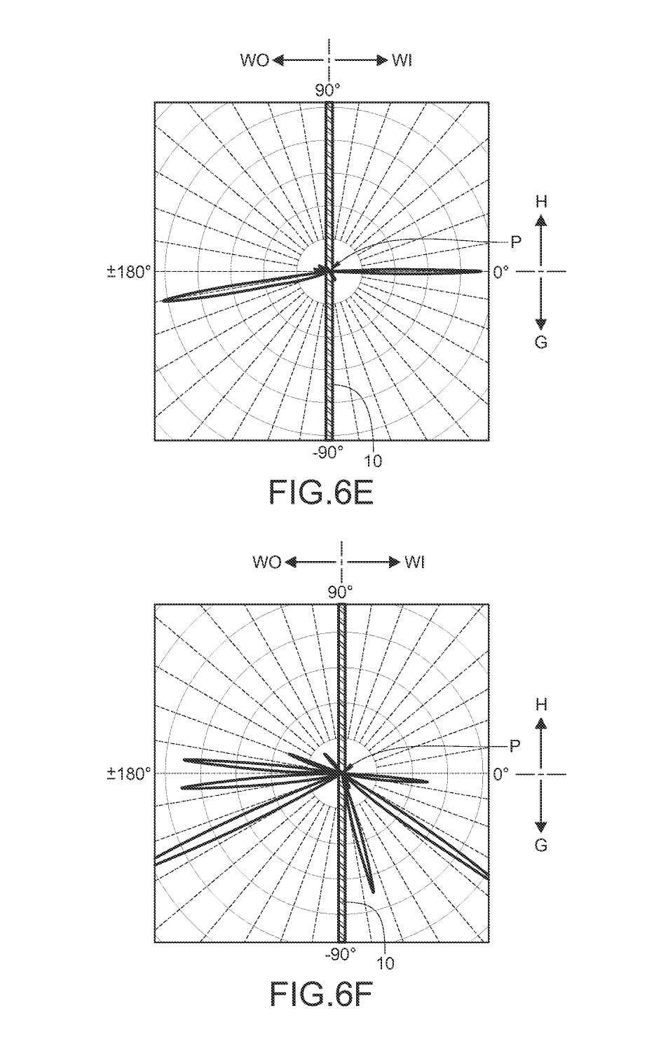

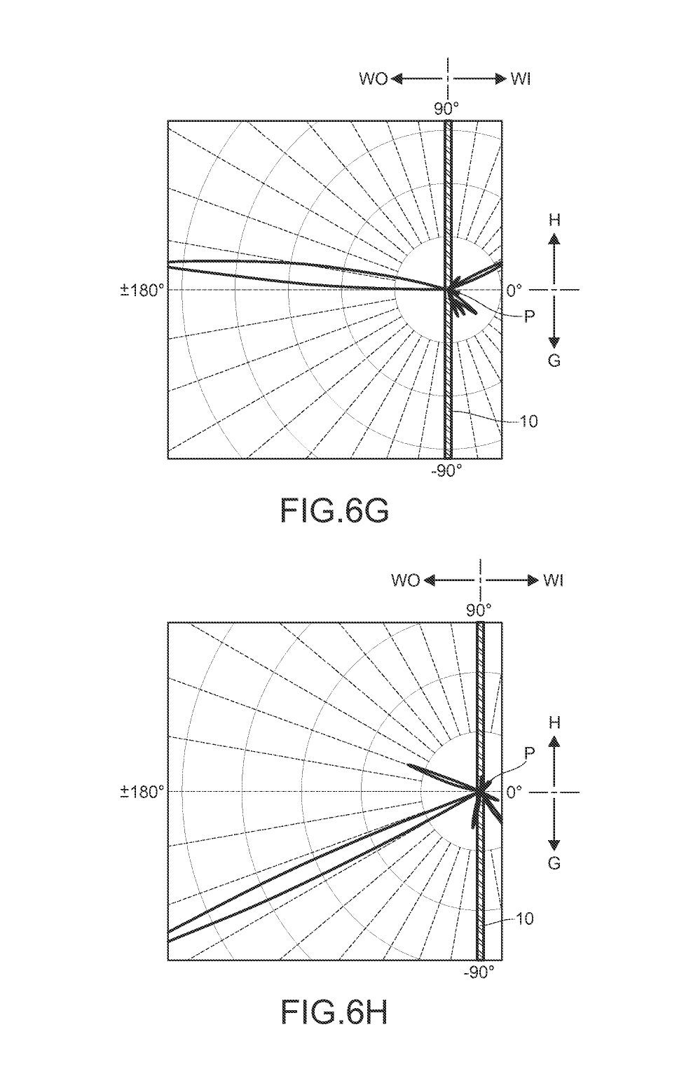

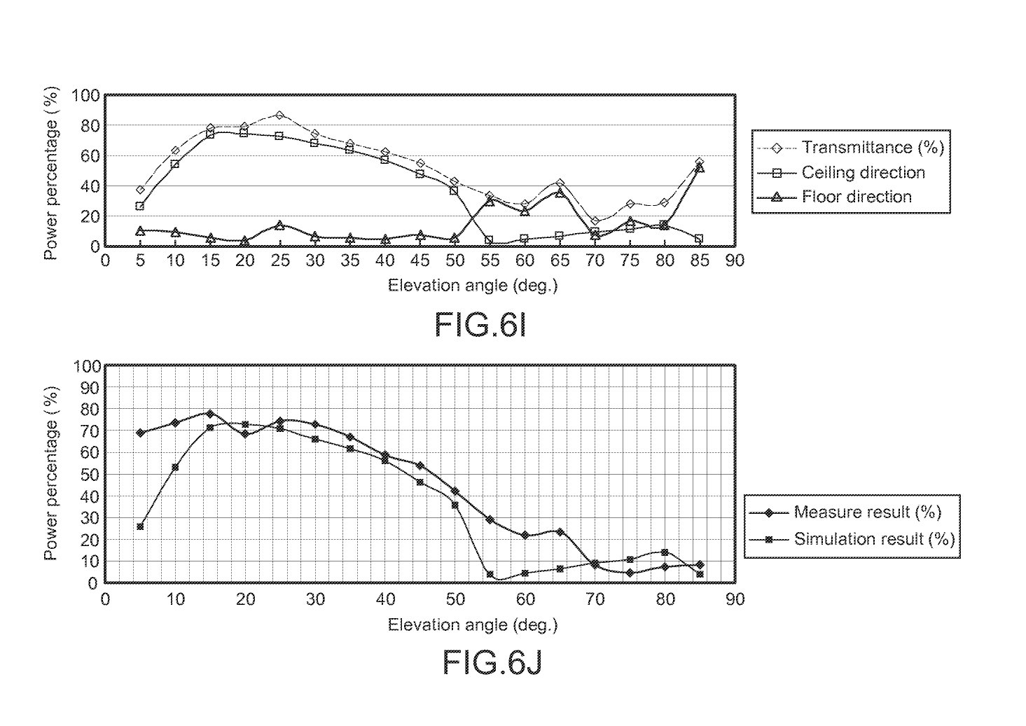

Referring to FIG. 6A to FIG. 6J, one embodiment based on the light deflection film 20 of FIG. 5 is provided. The distances S₁ and S₂ are 50 micrometer. The first angle θ1 is 2 degree. The second angle θ2 is 24 degree. The third angle θ3 is 2 degree. The fourth angle θ4 is 36 degree. The first light guiding plate 1D and the second light guiding plate 2D are made of UV glue. The transparent substrate ST is made of PET.

While Light 1 penetrates into the light deflection film 20 by different elevation angles α, the power percentages of the reflected light, the power percentages of the penetrating light, the power percentages of the light in the ceiling direction H (Upper Deflection Rate), and the power percentages of the light in the floor direction G (Down Defection Rate) are shown in Table 1.

TABLE 1

| | | | Upper | Down |
|---|---|---|---|---|
| α | Reflectance | Transmittance | Deflection | Deflection |
| (deg.) | (%) | (%) | Rate (%) | Rate (%) |
| 10 | 33.44 | 66.56 | 48.31 | 18.25 |
| 20 | 23.87 | 76.13 | 58.46 | 17.67 |
| 30 | 28.74 | 71.26 | 53.57 | 17.69 |
| 40 | 40.27 | 59.73 | 42.73 | 17 |
| 50 | 58.34 | 41.66 | 2.285 | 39.375 |
| 60 | 58.85 | 41.15 | 3.65 | 37.5 |
| 70 | 88.03 | 11.97 | 4.977 | 6.993 |
| 80 | 80.71 | 19.29 | 9.343 | 9.947 |

In this embodiment, the schematic diagrams of light distribution curve based on the elevation angles of 10, 20, 30, 40, 50, 60, 70 and 80 degree are respectively shown in FIG. 6A to FIG. 6H, and the power percentages of the light in the ceiling direction H and in the floor direction G are shown in FIG. 6I. If the elevation angle α is 50 degree, the light entering in to the indoor space WI is almost emitted out of the second light guiding plate 2D horizontally. If the elevation angle α is 85 degree, the light in the indoor space WI is almost deflected toward the floor near the window. The measure and simulation results of the power percentages of the light in the ceiling direction H are shown in FIG. 6J.

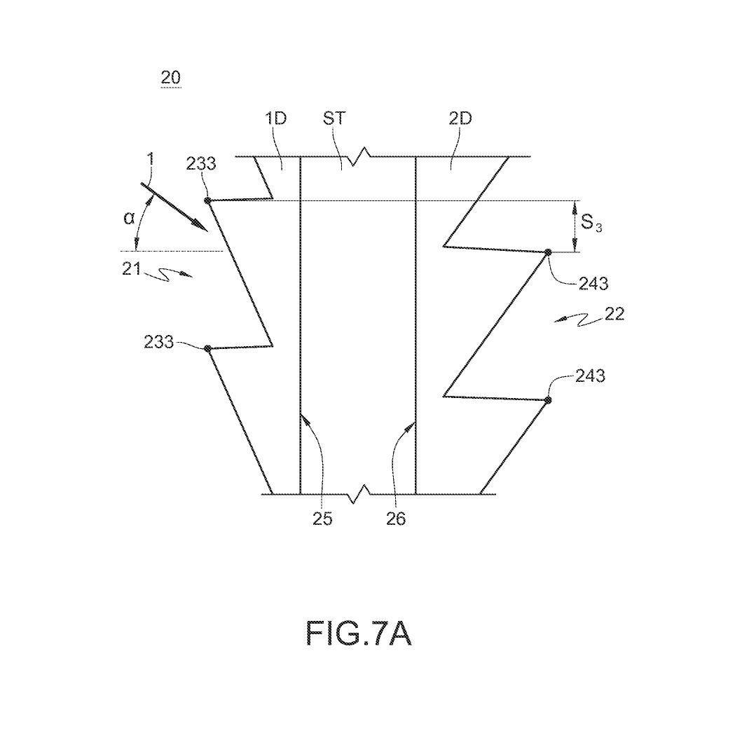

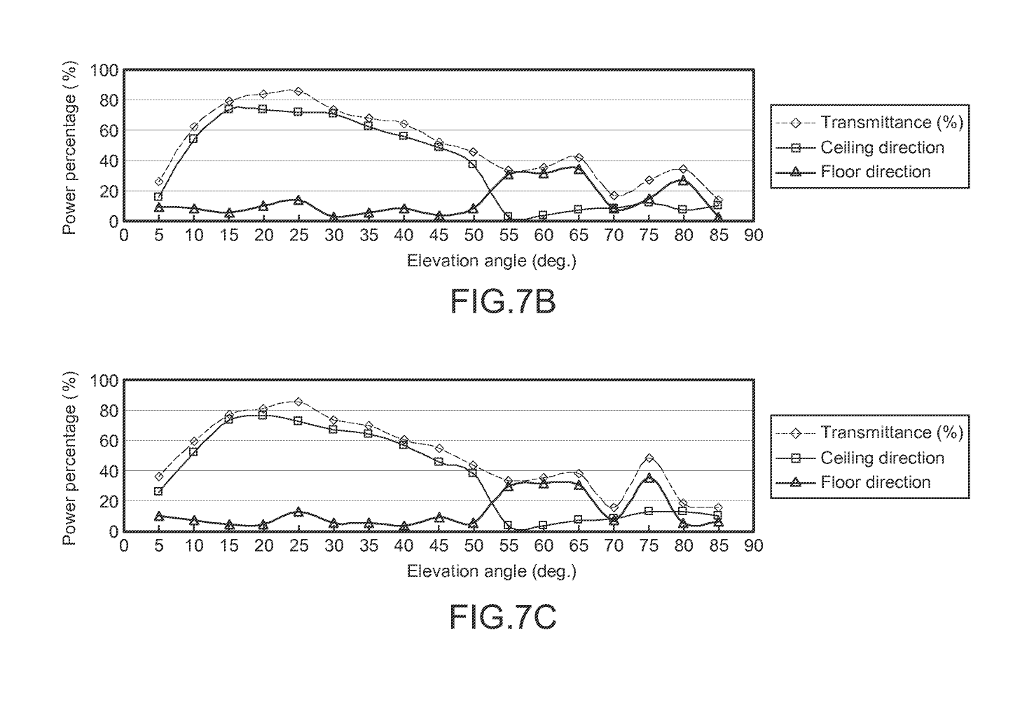

Referring to FIG. 7A, the difference between the third and fourth embodiments is that the position of the first vertex 233 of the first prism structure and the position of the second vertex 243 of the second prism structure are at different levels at Y axis in the fourth embodiment. More particularly, as compared with the position of each first prism structure at the Y-axis, the position of each second prism structure is shifted by a distance S₃ at the emission surface 22 along Y axis. The distance S₃ is the minimum height difference between the first vertex 233 and the second vertex 243. Other conditions of the fourth embodiment are equal to those of the third embodiment. The first light guiding plate 1D and the second light guiding plate 2D are made of UV glue. The transparent substrate ST is made of PET. Two embodiments of the light deflection film 20 of FIG. 7A are described in FIG. 7B and FIG. 7C.

In one embodiment, the first angle θ1 is 2 degree, the second angle θ2 is 24 degree, the third angle θ3 is 2 degree, the fourth angle θ4 is 36 degree, and the distance S₃ is 17 micrometer. When light 1 penetrates into such a light deflection film 20 of FIG. 7A by an elevation angle α of 5 to 85 degree respectively, the power percentage curves of the complete emitted light, of the deflected light in a ceiling direction, and of the deflected light in a floor direction are shown in FIG. 7B.

In another embodiment, the first angle θ1 is 2 degree, the second angle θ2 is 24 degree, the third angle θ3 is 2 degree, the fourth angle θ4 is 36 degree, and the distance S₃ is 34 micrometer. When light 1 penetrates into such a light deflection film 20 of FIG. 7A by elevation angles of 5 to 85 degree respectively, the power percentage curves of the complete emitted light, of the deflected light in a ceiling direction, and of the deflected light in a floor direction are shown in FIG. 7C.

According to FIG. 6I, FIG. 7B and FIG. 7C, if the shapes and the angles of each first prism structure 23 and of each second prism structure 24 in FIG. 5 are equal to those in FIG. 7A, it may not affect the efficiency of the light deflection film 20 guiding light 1 into the ceiling in the indoor space WI too much that the emission surface 22 is shifted by various distances S₃ as compared with the incident surface 21.

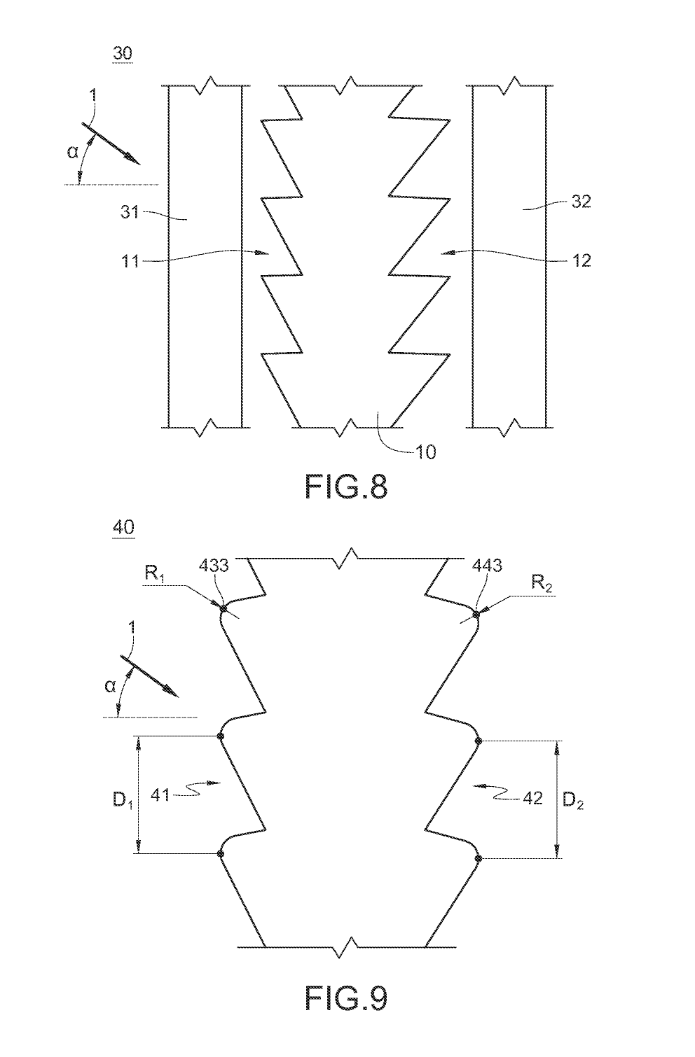

FIG. 8 illustrates a sectional schematic diagram of a profile structure of a light deflection film according to a fifth embodiment of the disclosure. In this embodiment, beside the light deflection film 10, the light deflection film 30 further includes a first protection layer 31 and a second protection layer 32. The incident surface 11 is disposed between the emission surface 12 and the first protection layer 31, and the emission surface 12 is disposed between the incident surface 11 and the second protection layer 32. Thus, the abrasion between the first prism structures and the second prism structures may be avoided, and the dusts accumulating on the light deflection film 30 may be cleaned more easily. The first protection layer 31 and the second protection layer 32 may be made of glass or other transparent material with great wear-resisting.

FIG. 9 illustrates a sectional schematic diagram of a profile structure of a light deflection film according to a sixth embodiment of the disclosure. The differences between the first and sixth embodiments are that a first arc angle R₁ is formed at each first vertex 433 and that a second arc angle R₂ is formed at each second vertex 443. A distance D₁ is formed between two adjacent first vertexes 433. A distance D₂ is formed between two adjacent second vertexes 443. The radius of the first arc angle R₁ and the radius of the second arc angle R₂ are equal to or larger than 0 micrometer and are less than or equal to 15 millimeter. Light 1 penetrates into the light deflection film 40 from the incident surface 41 and is emitted out of the emission surface 42. The definition of the angles of each prism structure is equal to that of the light deflection film 10 of the first embodiment.

In one embodiment based on FIG. 9, the distances D₁ and D₂ are 50 micrometer, the first angle θ1 is 0 degree, the second angle θ2 is 25 degree, the third angle θ3 is 0 degree, the fourth angle θ4 is 40 degree, the radius of the first arc angle R₁ is 11 micrometer, the radius of the second arc angle R₂ is 15 millimeter.

While Light 1 penetrates into the light deflection film 40 by different elevation angles α, the power percentages of the reflected light, the power percentages of the penetrating light, the power percentages of the light in the ceiling direction H (Upper Deflection Rate), and the power percentages of the light in the floor direction G (Down Defection Rate) are shown in Table 2.

TABLE 2

| | | | Upper | Down |
|---|---|---|---|---|
| α | Reflectance | Transmittance | Deflection | Deflection |
| (deg.) | (%) | (%) | Rate (%) | Rate (%) |
| 10 | 28.6 | 71.4 | 30.82 | 40.58 |
| 20 | 21.95 | 78.05 | 32.26 | 45.79 |
| 30 | 14.67 | 85.33 | 23.76 | 61.57 |
| 40 | 22.75 | 77.25 | 33.63 | 43.62 |
| 50 | 40.35 | 59.65 | 8.948 | 50.702 |
| 60 | 51.05 | 48.95 | 5.292 | 43.658 |
| 70 | 54.46 | 45.54 | 4.347 | 41.193 |
| 80 | 73.55 | 26.45 | 2.485 | 23.965 |

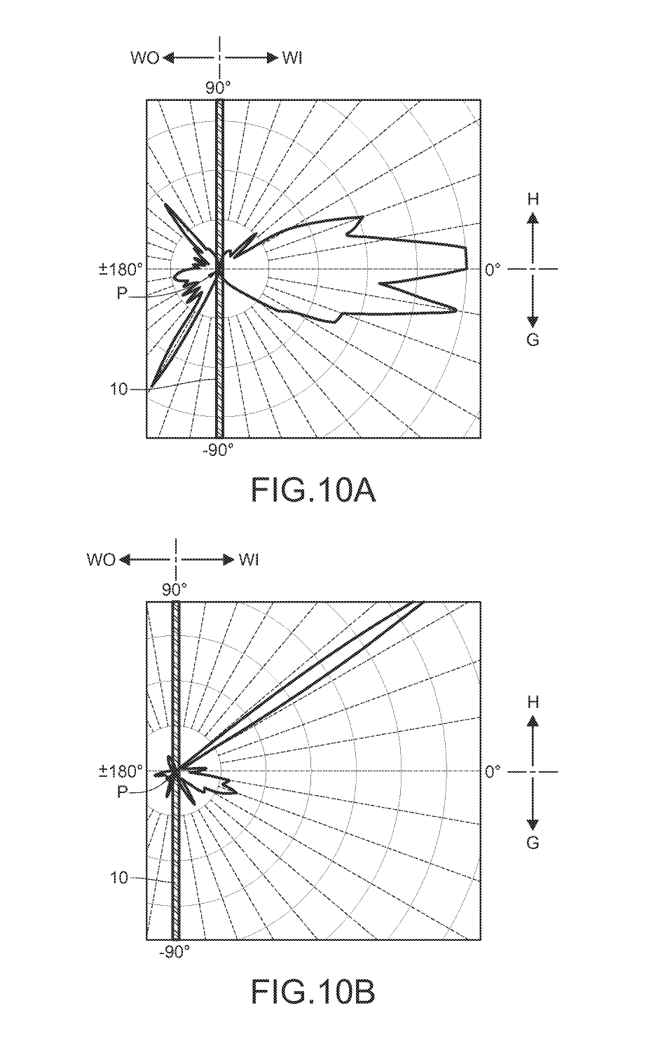

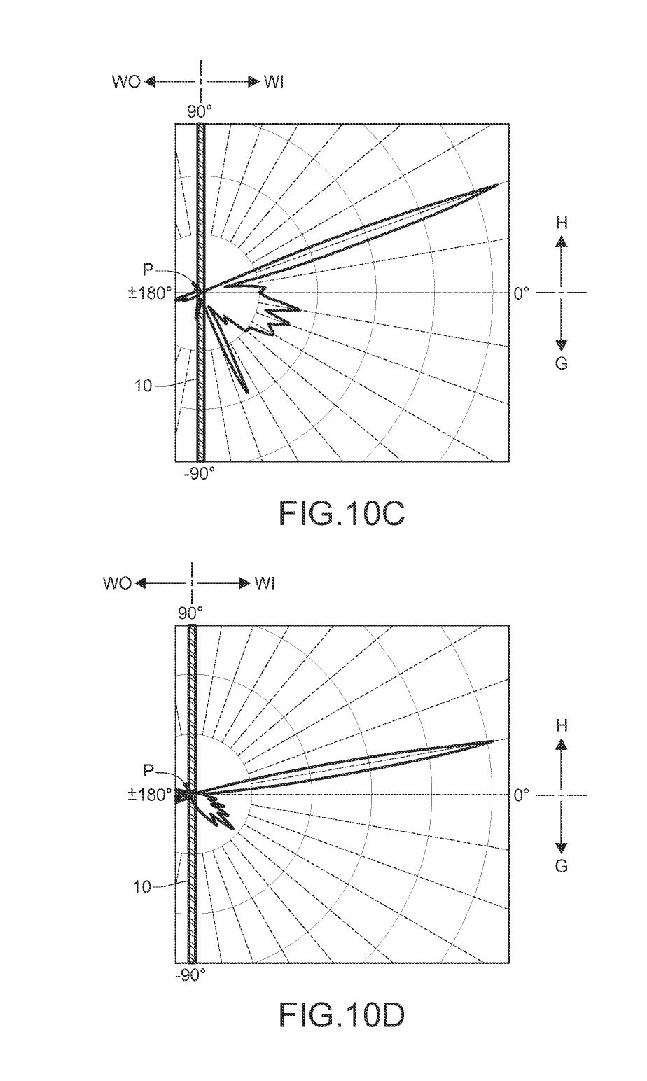

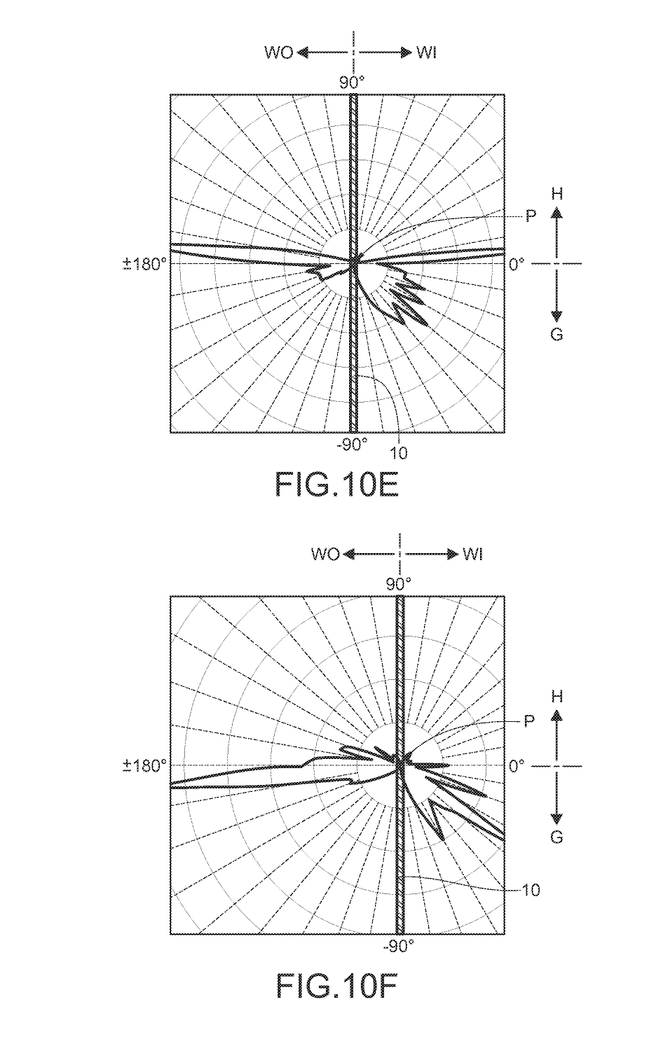

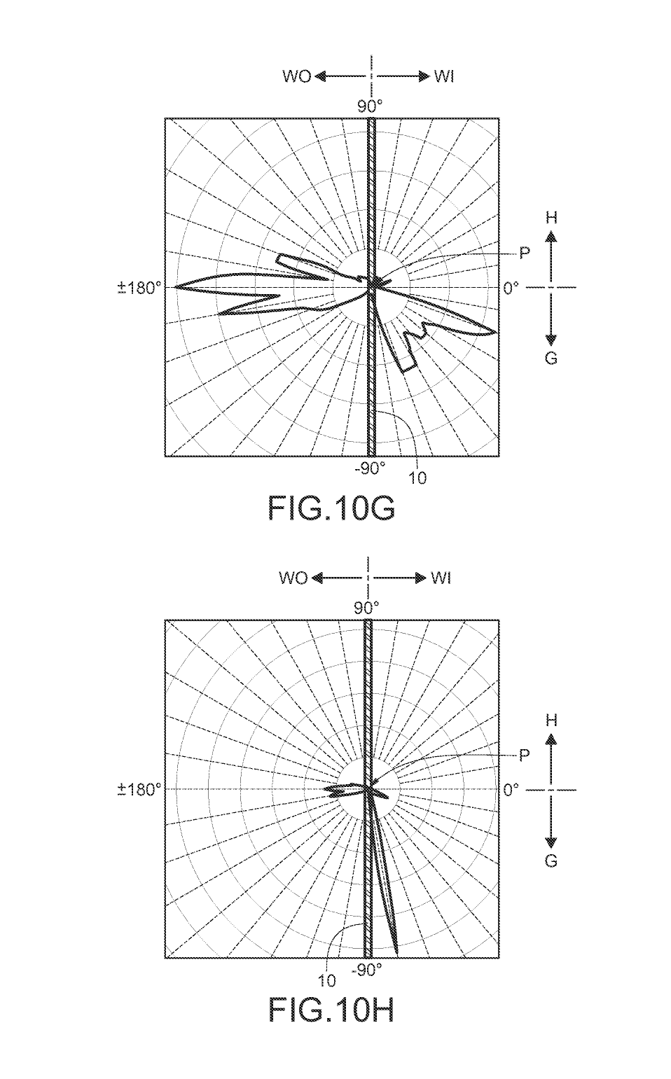

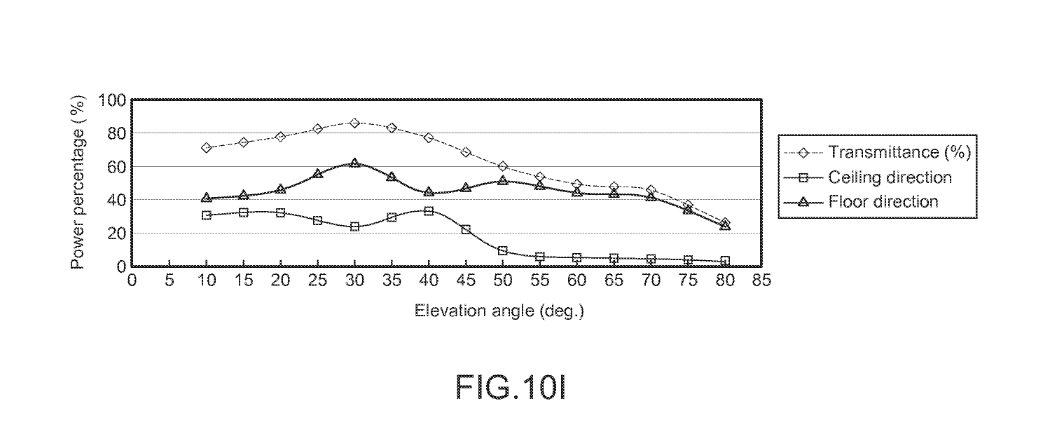

In this embodiment, the schematic diagrams of light distribution curve based on the elevation angles of 10, 20, 30, 40, 50, 60, 70 and 80 degree are respectively shown in FIG. 10A to FIG. 10H, and the power percentages of the light in the ceiling direction H and in the floor direction G are shown in FIG. 10I. If the elevation angle α is 80 degree, the light in the indoor space WI is almost deflected toward the floor near the window.

In another embodiment based on FIG. 9, the surfaces of at least one of each first prism structure 43 and each second prism structure 44 may satisfy the condition of a polynomial curve, or of an aspheric curve.

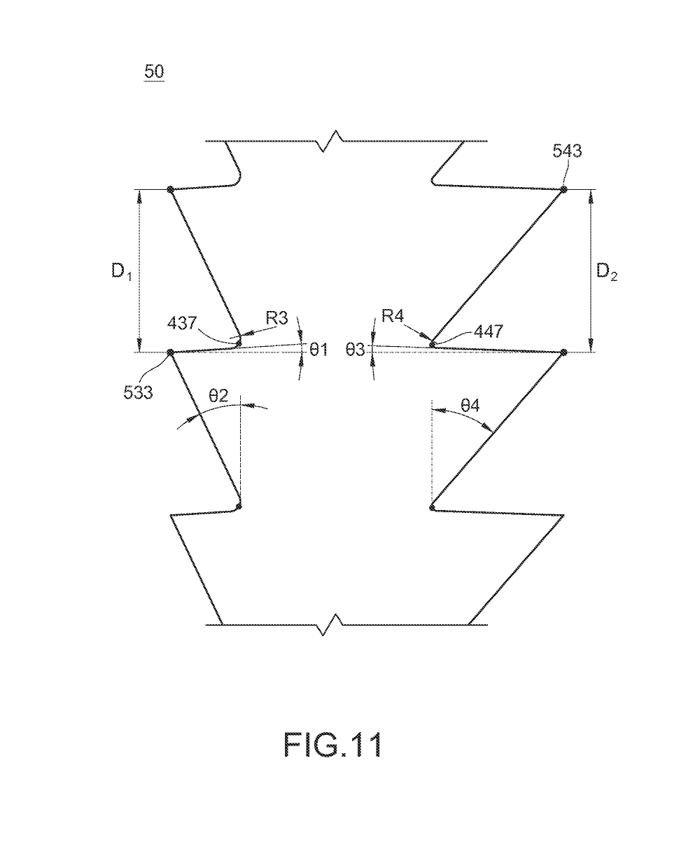

FIG. 11 illustrates a sectional schematic diagram of a profile structure of a light deflection film according to a seventh embodiment of the disclosure. The differences between the first and seventh embodiments are that a third arc angle R₃ is formed at a first junction point 437 formed by two adjacent first prism structures meeting, and that a fourth arc angle R₄ is formed at a second junction point 447 formed by two adjacent second prism structures meeting. The radius of the third arc angle R₃ and the radius of the fourth arc angle R₄ are larger than or equal to 0 micrometer and are less than or equal to 15 millimeter. A distance D₁ is formed between two adjacent first vertexes 533. A distance D₂ is formed between two adjacent second vertexes 543. The angles of each prism structure are equal to those of the light deflection film 10 of the first embodiment.

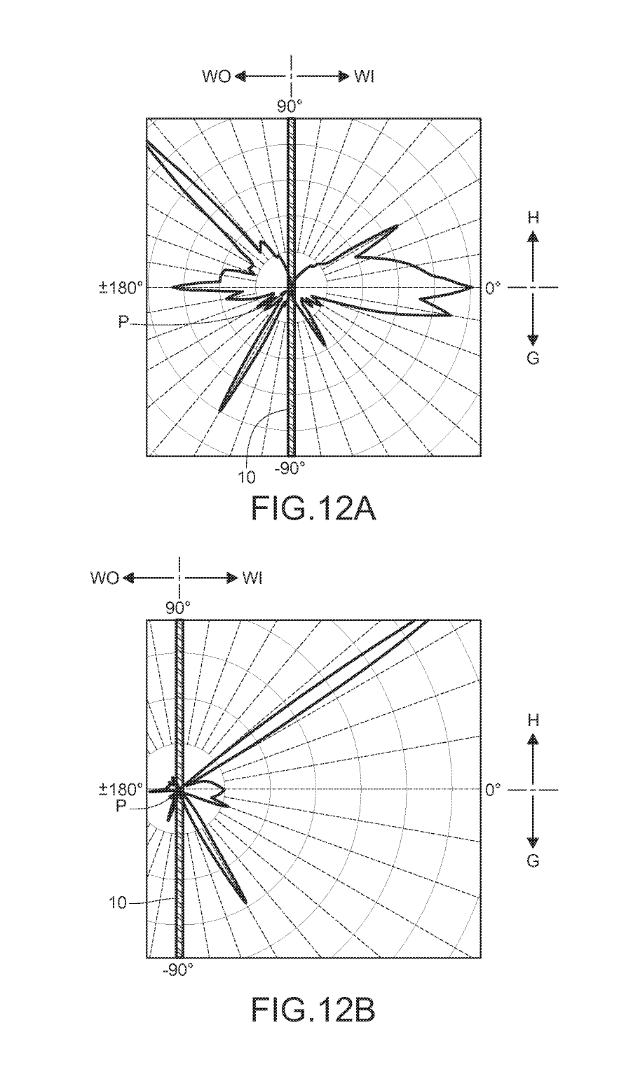

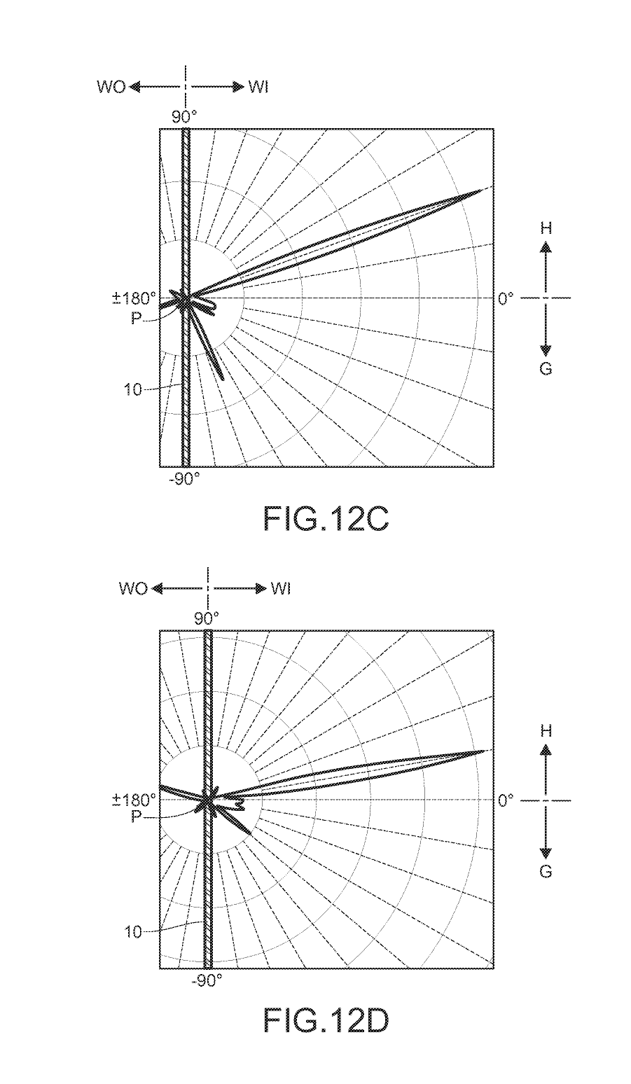

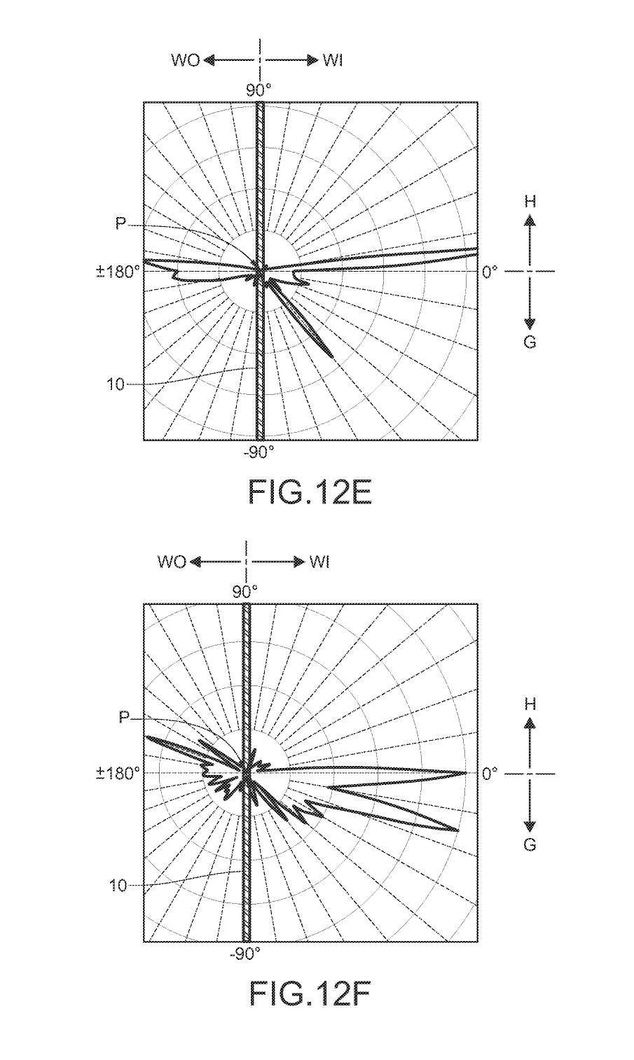

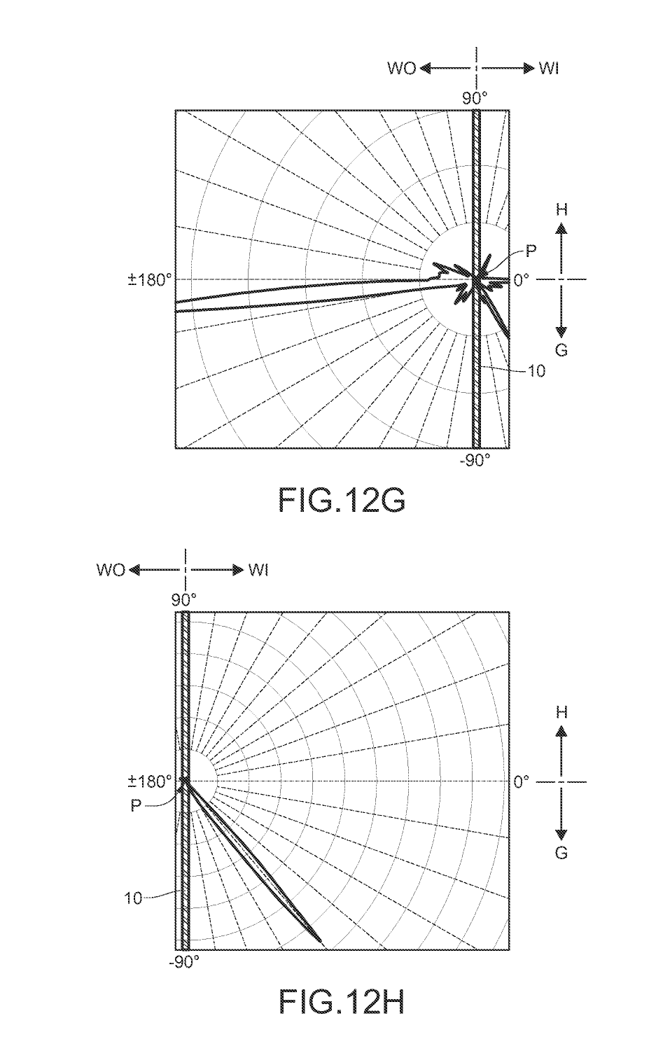

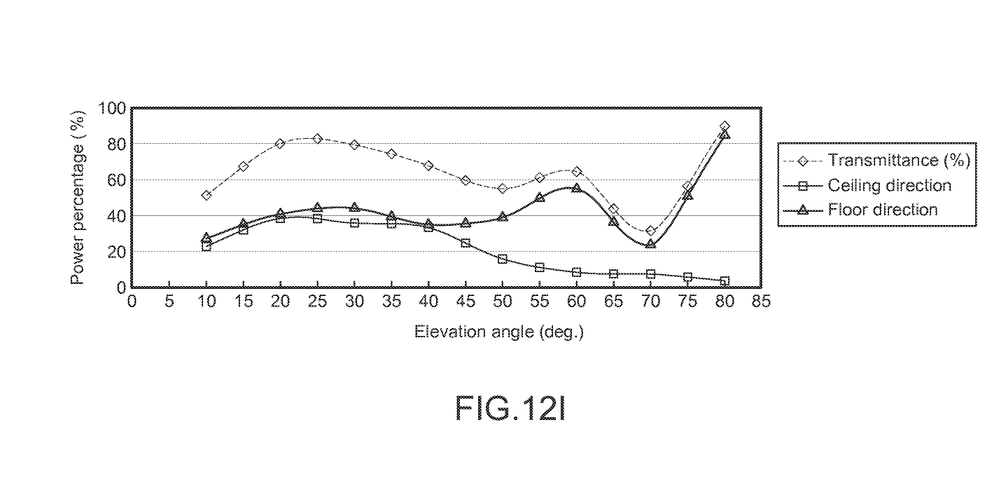

Referring to FIG. 12A to FIG. 12I, one embodiment based on the light deflection film 50 of FIG. 11 is provided. The distances D₁ and D₂ are 50 micrometer. The first angle θ1 is 0 degree. The second angle θ2 is 25 degree. The third angle θ3 is 0 degree. The fourth angle θ4 is 40 degree. The radius of the third arc angle R₃ is 0 micrometer. The radius of the fourth arc angle R₄ is 15 millimeter.

While Light 1 penetrates into the light deflection film 50 by different elevation angles α, the power percentages of the reflected light, the power percentages of the penetrating light, the power percentages of the light in the ceiling direction H (Upper Deflection Rate), and the power percentages of the light in the floor direction G (Down Defection Rate) are shown in Table 3.

TABLE 3

| | | | Upper | Lower |
|---|---|---|---|---|
| α | Reflectance | Transmittance | Deflection | Deflection |
| (deg.) | (%) | (%) | Rate (%) | Rate (%) |
| 10 | 48.95 | 51.05 | 23.5 | 27.55 |
| 20 | 20.05 | 79.95 | 38.64 | 41.31 |
| 30 | 21.01 | 78.99 | 35.36 | 43.63 |
| 40 | 32.35 | 67.65 | 32.95 | 34.7 |
| 50 | 45.86 | 54.14 | 15.29 | 38.85 |
| 60 | 35.93 | 64.07 | 8.405 | 55.665 |
| 70 | 68.82 | 31.18 | 7.394 | 23.786 |
| 80 | 10.95 | 89.05 | 3.547 | 85.503 |

In this embodiment, the schematic diagrams of light distribution curve based on the elevation angles of 10, 20, 30, 40, 50, 60, 70 and 80 degree are respectively shown in FIG. 12A to FIG. 12H, and the power percentages of the light in the ceiling direction H and in the floor direction G are shown in FIG. 12I. If the elevation angle α is 80 degree, the light in the indoor space WI is almost deflected toward the floor near the window.

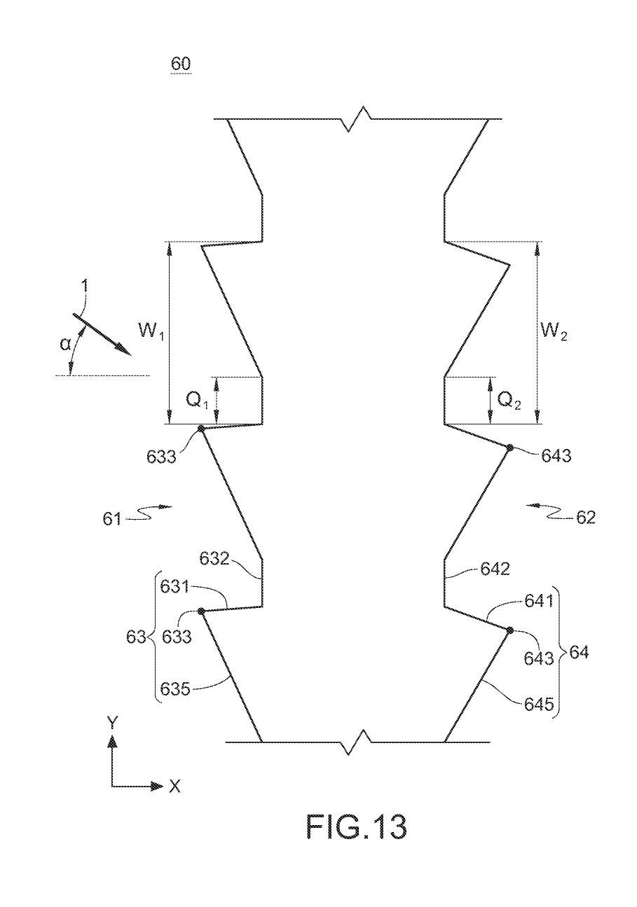

FIG. 13 illustrates a sectional schematic diagram of a profile structure of a light deflection film according to an eighth embodiment of the disclosure. The incident surface 61 includes a plurality of first prism structures 63 arranged at the incident surface 61 along Y-axis. The emission surface 62 includes a plurality of second prism structures 64 arranged at the emission surface 62 along Y-axis. Three first prism structures 63 and three second prism structures 64 are taken in FIG. 13 for illustration purpose hereinafter.

Each first prism structure 63 includes a first surface 631 and a second surface 635. The first surface 631 and the second surface 635 meet to form a first vertex 633. A distance W₁ between two adjacent first vertexes 633 is from 1 micrometer to 20 millimeter. Each second prism structure 64 includes a third surface 641 and a fourth surface 645. The third surface 641 and the fourth surface 645 meet to form a second vertex 643. A distance W₂ between two adjacent second vertexes 643 is from 1 micrometer to 20 millimeter. The angles of each prism structure are equal to the light deflection film 10 of the first embodiment.

Besides, the incident surface 61 further includes fifth surfaces 632, and the emission surface 62 further includes sixth surfaces 642. The fifth surface 632 is disposed between two adjacent first prism structures 63. The fifth surface 632 respectively connects to the first surface 631 of one of the two adjacent first prism structures 63 and the second surface 635 of another one of the two adjacent first prism structures 63. The length Q₁ of the fifth surface 632 is less than or equal to a half of the distance W₁. The sixth surface 642 is disposed between two adjacent second prism structures 64. The sixth surface 642 respectively connects to the third surface 641 of one of the two adjacent second prism structures 64 and the fourth surface 645 of another one of the two adjacent second prism structures 64. The length Q₂ of the sixth surface 642 is less than or equal to a half of the distance W₂. The penetrability of the light deflection film 60 is increased as the percentage of the length Q₁ in the distance W₁ and the percentage of the length Q₂ in the distance W₂ are higher.

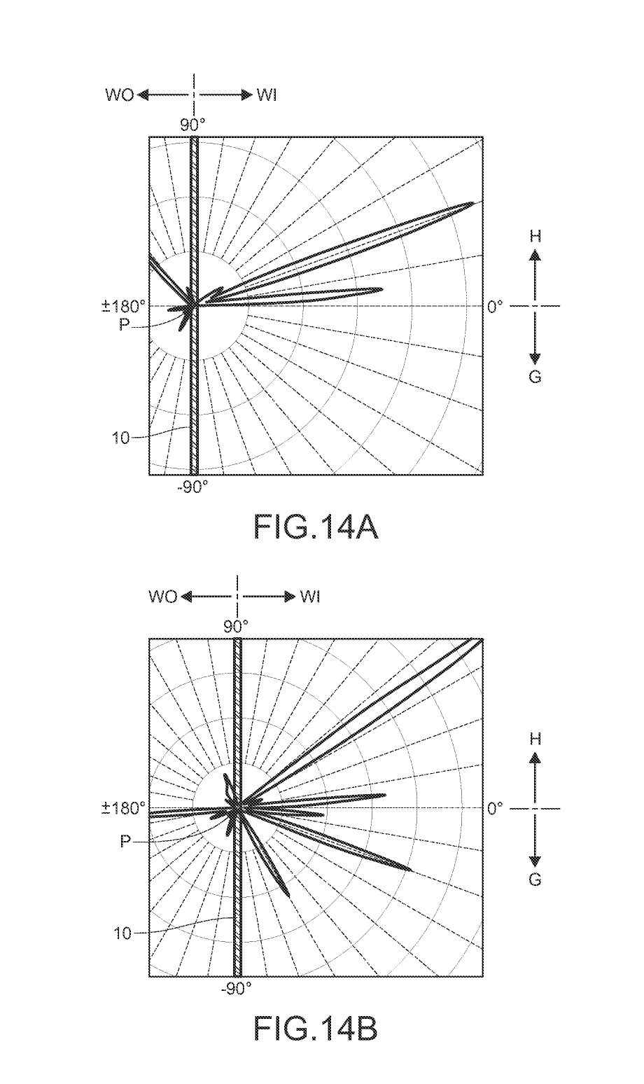

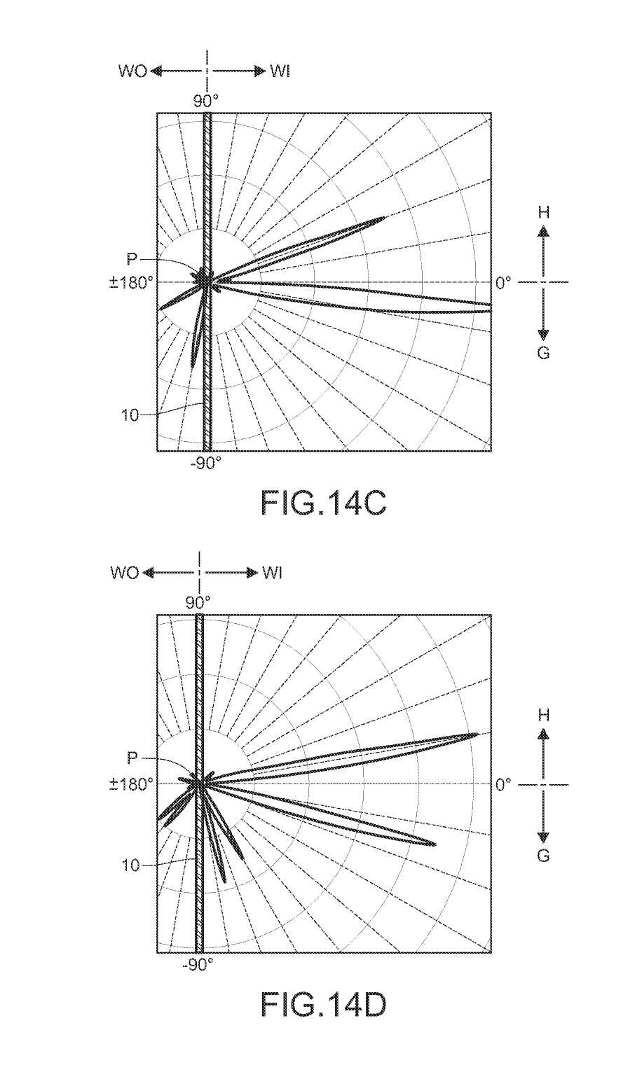

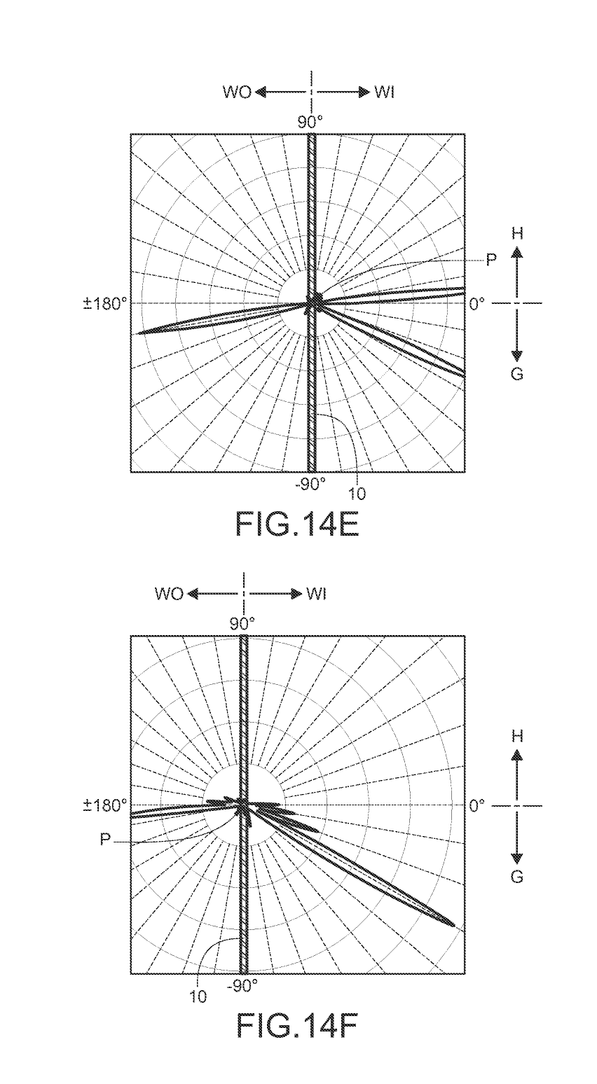

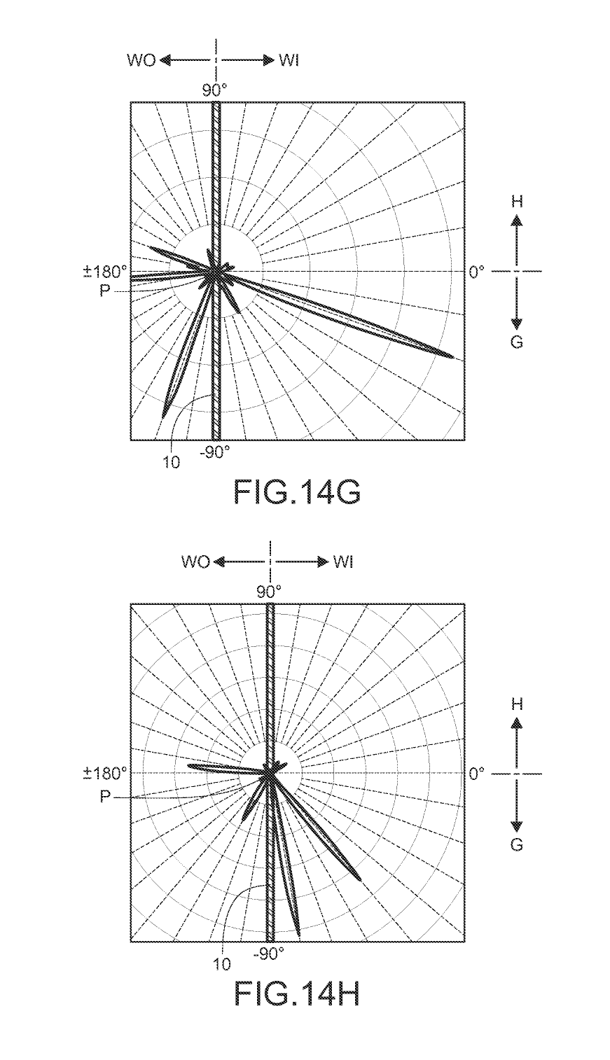

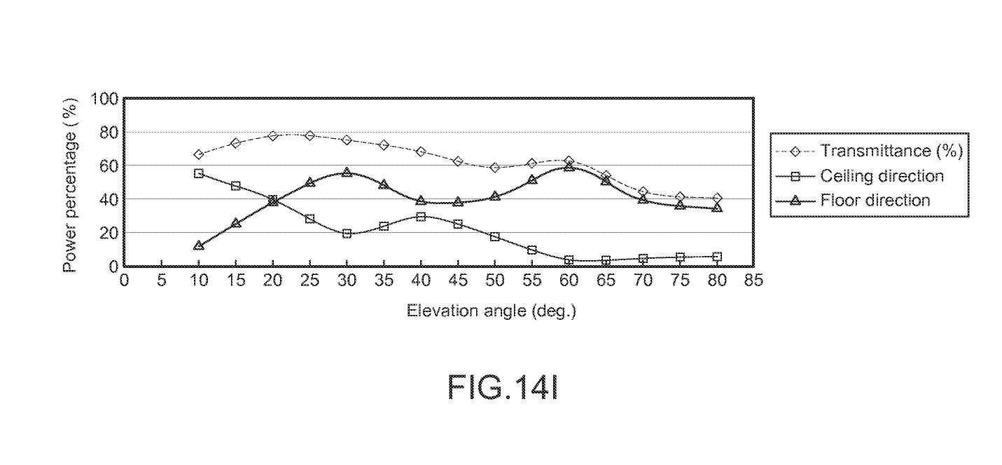

Referring to FIG. 14A to FIG. 14I, one embodiment based on the light deflection film 60 of FIG. 13 is provided. The distances W₁ and W₂ are 70 micrometer. The lengths Q₁ and Q₂ are 25 micrometer. The first angle θ1 is 0 degree. The second angle θ2 is 25 degree. The third angle θ3 is 0 degree. The fourth angle θ4 is 40 degree.

While Light 1 penetrates into the light deflection film 60 by different elevation angles α, the power percentages of the reflected light, the power percentages of the penetrating light, the power percentages of the light in the ceiling direction H (Upper Deflection Rate), and the power percentages of the light in the floor direction G (Down Defection Rate) are shown in Table 4.

TABLE 4

| | | | Upper | Lower |
|---|---|---|---|---|
| α | Reflectance | Transmittance | Deflection | Deflection |
| (deg.) | (%) | (%) | Rate (%) | Rate (%) |
| 10 | 32.71 | 67.29 | 55.25 | 12.04 |
| 20 | 22.08 | 77.92 | 39.83 | 38.09 |
| 30 | 24.47 | 75.53 | 19.6 | 55.93 |
| 40 | 31.44 | 68.56 | 29.83 | 38.73 |
| 50 | 41.26 | 58.74 | 17.74 | 41 |
| 60 | 37.3 | 62.7 | 3.885 | 58.815 |
| 70 | 55.38 | 44.62 | 5.187 | 39.433 |
| 80 | 59.36 | 40.64 | 5.767 | 34.873 |

In this embodiment, the schematic diagrams of light distribution curve based on the elevation angles of 10, 20, 30, 40, 50, 60, 70 and 80 degree are respectively shown in FIG. 14A to FIG. 14H, and the power percentages of the light in the ceiling direction H and in the floor direction G are shown in FIG. 14I. If the elevation angle α is 80 degree, the light in the indoor space WI is almost deflected toward the floor near the window.

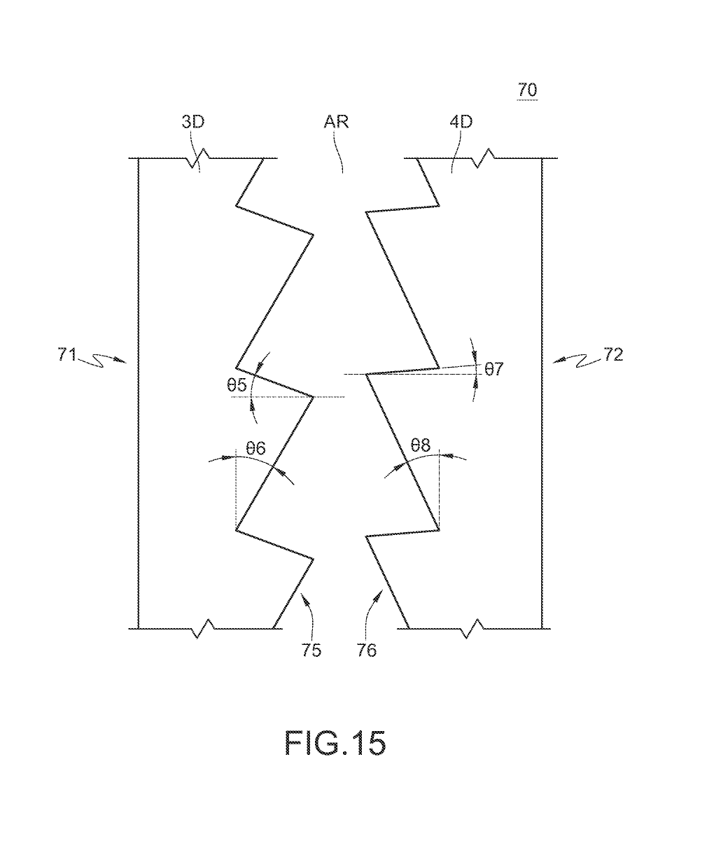

FIG. 15 illustrates a sectional schematic diagram of a profile structure of a light deflection film according to a ninth embodiment of the disclosure. The light deflection film 70 includes a first light guiding plate 3D and a second light guiding plate 4D. An air layer AR fills the space between the first light guiding plate 3D and the second light guiding plate 4D so as to avoid which the dusts covering on the prism structures effects the guiding efficient.

The first light guiding plate 3D includes an incident surface 71 and a first structure surface 75. The first light guiding plate 3D includes a plurality of first prism structures. The second light guiding plate 4D includes a second structure surface 76 and an emission surface 72. The second structure surface 76 includes a plurality of second prism structures. The first structure surface 75 and the second structure surface 76 are opposite. Light 1, in order, penetrates into the first light guiding plate 3D from the incident surface 71, is emitted out of the first structure surface 75, penetrates the air layer AR, penetrates into the second light guiding plate 4D from the second structure surface 76, and is emitted out of the emission surface 72.

The definition of angles of prism structures is equal to the light deflection film 10 of the first embodiment. The ranges of the first angle θ5 to the fourth angle θ8 may differ from the ranges of the first angle θ1 to the fourth angle θ4 of the light deflection film 10 of the first embodiment. The first angle θ5 may be, but not limit to, from 0 to 15 degree. In one embodiment, the first angle θ5 is from 0 to 10 degree. The second angle θ6 may be, but not limit to, from 15 to 45 degree. In one embodiment, the second angle θ6 is from 25 to 35 degree. The third angle θ7 may be, but not limit to, from 0 to 15 degree. In one embodiment, the third angle is from 0 to 10 degree. The fourth angle θ8 may be, but not limit to, from 5 to 30 degree. In one embodiment, the fourth angle θ8 is from 15 to 25 degree.

Besides, the ranges of the second angle θ6 and the fourth angle θ8 may be exchanged. In other word, the ranges of the second angle θ6 and the fourth angle θ8 are from 5 to 45 degree.

By arranging the distance between two adjacent first vertexes, the distance between two adjacent second vertexes, the first angle, the second angle, the third angle and the fourth angle, incident light with an elevation angle larger than 55 degree is almost reflected by the light deflection film of the disclosure, and incident light with an elevation angle of from 0 to 45 degree is almost deflected upward by the light deflection film of the disclosure. By adding the first protection layer and the second protection layer, the first prism structures and the second prism structures may not be abraded, and the dusts on the light deflection film may be clean easily. Through the fifth surface and the sixth surface, outdoor scenery may be more observable. By forming the first arc angle and the second arc angle or forming third arc angle and the fourth arc angle, light is deflected upward the ceiling direction more uniformly.

Thus, by designing the incident surface and the emission surface, the light deflection film selectively reflects light or deflected light upward, the sunlight guided into indoor space may become an indirect illumination and not become glare to human eyes, and the light deflection film may carry out the purpose of illumination energy conservation.

The disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and region of equivalency of the claims are to be embraced within their scope.

What is claimed is:

1. A light deflection film, adapted to receive light and comprising:
an incident surface, for receiving light, the incident surface comprising a plurality of first prism structures, the first prism structure comprising a first surface and a second surface, a first angle between the first surface and a X-axis being 0 to 20 degree, a second angle between the second surface and a Y-axis being 5 to 60 degree; and
an emission surface, comprising a plurality of second prism structures, the second prism structure comprising a third surface and a fourth surface, a third angle between the third surface and the X-axis being 0 to 20 degree, a fourth angle between the fourth surface and the Y-axis being 5 to 60 degree, and light emitted out of the emission surface after penetrating the light deflection film.

2. The light deflection film according to claim 1, wherein the first and second surfaces of the first prism structure meet to form a first vertex, and a distance between two adjacent ones of the first vertexes is from 1 micrometer to 20 millimeter.

3. The light deflection film according to claim 1, wherein the third and fourth surfaces of the second prism structure meet to form a second vertex, and a distance between two adjacent ones of the second vertexes is from 1 micrometer to 20 millimeter.

4. The light deflection film according to claim 1, wherein a fifth surface is formed between two adjacent ones of the first prism structures and respectively connects to the first surface of one of the two adjacent first prism structures and the second surface of the other one of the two adjacent first prism structures, and a length of the fifth surface is less than or equal to a half of a distance between two adjacent ones of the first prism structures.

5. The light deflection film according to claim 1, wherein a sixth surface is formed between two adjacent ones of the second prism structures and respectively connects to the third surface of one of the two adjacent second prism structures and the fourth surface of the other one of the two adjacent second prism structures, and a length of the sixth surface is less than or equal to a half of a distance between two adjacent ones of the second prism structures.

6. The light deflection film according to claim 1, wherein the first and second surfaces of the first prism structure meet to form a first vertex, a first arc angle is formed at the first vertex, the third and fourth surfaces of the second prism structure meet to form a second vertex, a second arc angle is formed at the second vertex.

7. The light deflection film according to claim 6, wherein a radius of the first arc angle is larger than 0 micrometer and is less than or equal to 15 millimeter, a radius of the second arc is larger than 0 micrometer and is less than or equal to 15 millimeter.

8. The light deflection film according to claim 1, further comprising a first light guiding plate, a second light guiding plate, a transparent plate, wherein the first light guiding plate comprises the incident surface and a first plat surface opposite to the incident surface, the second light guiding plate comprises the emission surface and a second plat surface opposite to the emission surface, and the transparent plate is disposed between the first light guiding plate and the second light guiding plate.

9. The light deflection film according to claim 1, further comprising a first protection layer and a second protection layer, wherein the incident surface is disposed between the emission surface and the first protection layer, the emission surface is disposed between the incident surface and the second protection layer.

10. The light deflection film according to claim 1, wherein a position of the second prism structure is shifted a distance at the emission surface as compared with a position of the first prism structure at the incident surface.

11. The light deflection film according to claim 1, wherein a third arc angle is formed at a first junction point which two adjacent ones of the first prism structures meet to form, and the third arc angle is from 0 to 15 millimeter.

12. The light deflection film according to claim 1, wherein a fourth arc angle is formed at a second junction point which two adjacent ones of the second prism structures meet to form, and the fourth arc angle is from 0 to 15 millimeter.

13. A light deflection film, adapted to receive light and comprising:
a first light guiding plate, comprising an incident surface and a first structure surface comprising a plurality of first prism structures, the first prism structure comprising a first surface and a second surface, a first angle between the first surface and a X-axis being 0 to 15 degree, a second angle between the second surface and a Y-axis being 5 to 45 degree;
a second light guiding plate, comprising an emission surface and a second structure surface comprising a plurality of second prism structures, the second prism structure comprising a third surface and a fourth surface, a third angle between the third surface and the X-axis being 0 to 15 degree, a fourth angle between the fourth surface and the Y-axis being 5 to 45 degree; and
an air layer, disposed between the first light guiding plate and the second light guiding plate, light penetrating into the light deflection film from the incident surface and emitted out of the emission surface.

14. The light deflection film according to claim 13, wherein the first and second surfaces of the first prism structure meet to form a first vertex, and a distance between two adjacent ones of the first vertexes is from 1 micrometer to 20 millimeter.

15. The light deflection film according to claim 13, wherein the third and fourth surfaces of the second prism structure meet to form a second vertex, and a distance between two adjacent ones of the second vertexes is from 1 micrometer to 20 millimeter.
